(19) United States
(12) Patent Application Publication
(10) Pub. No.: US 2006/0154126 A1
(43) Pub. Date: Jul. 13, 2006

(54) Fuel cells including biocompatible membranes and metal anodes

(76) Inventors: Rosalyn Ritts, Princeton, NJ (US); Hoi-Cheong Steve Sun, Dayton, NJ (US); Richard T. Whipple, Raritan, NJ (US); Steven Alan Lipp, West Windsor, NJ (US); Susan Klatskin, Lawrenceville, NJ (US)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 10/529,813

(22) PCT Filed: Oct. 3, 2003
(86) PCT No.: PCT/US03/31457

§ 371 Date: Oct. 12, 2005

(30) Foreign Application Priority Data
Oct. 3, 2002 (US) 60415701

(51) Int. Cl. H01M 8/10; H01M 8/16; H01M 12/00

(52) U.S. Cl. 429/29; 429/33; 429/2

(57) ABSTRACT

The present invention relates to a fuel cell including a metal anode as fuel and a biocompatible membrane.

### CROSS-REFERENCE TO RELATED APPLICATIONS

This application claims priority to provisional application No. 60/415,701, filed Oct. 3, 2002, the contents of which are incorporated by reference.

### BACKGROUND OF THE INVENTION

In one series of articles by Meier et al., various constructions were proposed for polymer based membranes, which included functional proteins. While such membranes had been the subject of speculation in the past, this is believed to be the first successful biological protein containing polymer based membrane that included an imbedded enzyme that retained its functionality. See Corinne Nardin, Wolfgang Meier et al., 39 Angew Chem. Int. Ed., 4599-602 (2000); Langmuir, 16 1035-41 (2000); and Langmuir, 16 7708-12 (2000). These articles describe a functionalized poly(2-methyloxazoline)-block-poly(dimethylsiloxane)-block-poly(2-methyloxazoline) triblock copolymer in which a protein (a “porin”—a non-selective, passive pore-forming molecule) is embedded.

The Meier et al. work is unique and limited in scope. It does not broadly discuss the use of polymers, nor suggest that even the polymer membrane disclosed could be used in conjunction with even other enzymes. Certainly nothing in these articles suggests the possibility of creating a synthetic membrane containing an embedded biological species capable of participating in oxidation or reduction, or “polypeptide mediated transporting of active molecules, atoms, protons or electrons across the membrane.” Indeed, the narrowness of the disclosure and the lack of other successes offer little reason for optimism that other biological materials could be successfully embedded into polymer membranes.

The creation of membranes for the study of membrane associated proteins has long been known. See Functional Assembly of Membrane Proteins in Planar Lipid Bilayers, 14 Quart. Rev. Biophys., 1-79 (1981). Indeed, transmembrane and redox proteins were embedded in biologically based membranes, e.g., membranes produced of molecules found in living cells or organisms, for purposes of studying their structure and mechanism. The use of lipid bilayers containing embedded enzyme complexes such as NADH dehydrogenase from E. coli, which can transport protons across the membrane and/or participate in redox reactions has also been described. See Liberatore et al., U.S. Patent Application Publication No. US 2002/0001739 A1, published Jan. 3, 2002. Indeed, Liberatore et al. described the use of such membranes as part of a battery.

Neither the existence of biological membranes containing enzyme complexes nor the discovery of a single combination of a polymer membrane and a specific enzyme offers much hope for the development of a broad class of synthetic, biocompatible polymer membranes, which are stable and functional. See also G. Tayhas et al. “A Methanol/Dioxogen Biofuel Cell That Uses NAD+ Dependent Dehydrogenases as Catalysts: Application of an Electro-Enzymatic Method to Regenerate Nicotinamide Adenine Dinucleotide at Low Overpotentials,” 43 J. Electroanalytical Chem. 155-161 (1998).

Metal anodes including those made from, inter alia, zinc or aluminum and their use in fuel cells are also known. However, such fuel cells have several disadvantages. First, once their energy generating reaction begins, it usually must run to completion, even where current is not being drawn from the fuel cell. Thus, the cell can be completely consumed even when used for only a fraction of its available power. Second, these fuel cells often use separators or barriers between the anode and cathode that allow for the transfer of metal ions that can plate the cathode and reduce efficiency.

### SUMMARY OF THE INVENTION

The present invention solves many of these problems by providing a fuel cell including a metal anode and a biocompatible membrane that is impervious to the passage of metals and metal ions, but is capable of participating in transporting protons or positive charges. When discussing metals and metal ions herein, it will be appreciated that these terms refer to those metals described above as useful anode electrodes, and not to alkali metals or ions which may be used in electrolytes. A biocompatible membrane in accordance with one aspect of the present invention including at least one layer of a synthetic polymer material having a first side and a second side. The biocompatible membrane includes at least one polypeptide associated therewith.

In a particularly preferred aspect, the present invention relates to a biocompatible membrane wherein the polypeptide is capable of participating in a chemical reaction, participating in the transporting of molecules, atoms, protons or electrons from the first side of the at least one layer to the second side of the same layer or participating in the formation of molecular structures that facilitate such reactions or transport. In an even more particularly preferred aspect of the invention, the polypeptide is capable of participating in the transmembrane transport of protons. When discussing transporting protons across a biocompatible membrane, it will be appreciated that neither the exact mechanism, nor the exact species transferred is known. The transferred species might be a proton per se, a positively charged hydrogen, a hydronium ion, H₃O⁺ or indeed some other charged species. For convenience, however, these will be collectively discussed herein as “protons.” The biocompatible membrane therefore must permit the passage of protons but not metal ions from the anode compartment to cathode compartment.

Any synthetic polymer material which is a block copolymer, copolymer or polymer or mixtures thereof may be used in accordance with the present invention so long as they are capable of forming biocompatible membrane having the properties described herein. In one preferred aspect of the present invention, the synthetic polymer material includes at least one block copolymer. Mixtures of block copolymers are also contemplated. Optionally, the synthetic polymer material will include at least one additive. In a second preferred embodiment in accordance with the present invention, the synthetic polymer material includes at least one polymer, copolymer or block copolymer or a mixture of these in any combination. An optional additive is also contemplated. In another preferred embodiment of the present invention, the synthetic polymer material can be any polymer material capable of forming a biocompatible membrane and includes in addition thereto at least one stabilizing polymer. Additives are also contemplated.

In another aspect of the present invention, the synthetic polymer material is a block copolymer, a mixture of block copolymers or a structure formed from a first layer of one or more block copolymers and a second layer formed from a polymer that may stabilize or enhance the functionality or longevity of the first layer. Preferably, the polypeptide is embedded in the synthetic polymer material so as to form a biocompatible membrane.

“Biocompatible membrane” as used herein is one or more layers of a synthetic polymeric material forming a sheet, plug or other structure that can be used as a membrane and is associated with a polypeptide or other molecule, often of biological origin. By “biocompatible,” it is meant that the membrane itself is made of synthetic polymer materials that will not incapacitate or otherwise block all of the functionality of a polypeptide when they are associated with one another. A “membrane” as used herein is a structure such as a sheet, layer or plug of a material that includes, at least as its major structural component, synthetic polymer materials and can be used to selectively segregate space, fluids (liquids or gases), solids and the like. A membrane as used herein may include permeable materials that allow the passage or diffusion of some species from one side to the other. A membrane used in a fuel cell, for example, prevents the passage of some components from within a cathode compartment into the anode compartment and/or prevents some components within the anode compartment from passing into the cathode compartment. Other components, however, may pass freely. At the same time, as exemplified in one embodiment of a membrane in accordance with the present invention, it will permit and indeed facilitate the passage of protons from the anode compartment to the cathode compartment. The biocompatible membrane will not, however, permit the passage of metal and, in particular, metal ions; with a maximum leakage ratio of metal ions to protons of one per hundred.

“Associated” in accordance with the present invention can mean a number of things depending on the circumstances. A polypeptide can be associated with a biocompatible membrane by being bound to one or more of the surfaces thereof, and/or by being wedged or bound within one or more of the surfaces of the membrane (such as in recesses or pores). The “associated” polypeptide can be disposed within the interior of the membrane or in a vesicle or lumen contained within the membrane. Polypeptides could also be disposed between successive layers. Polypeptides may be embedded in the membrane as well. Indeed, in a particularly preferred embodiment, the polypeptide is embedded or integrated in the membrane in such a way so that it is at least partially exposed through at least one surface of the membrane and/or can participate in a redox reaction or in the polypeptide mediated transporting of a molecule, atom, proton or electron from one side of the membrane to the other.

The term “participate” in the context of transporting a molecule, atom, proton or electron, from one side of the membrane to the other includes active transport where, for example, the polypeptide physically or chemically “pumps” the molecule, atom, proton or electron across the membrane, usually, but not exclusively, against a pH or concentration gradient or any other active transport mechanism. However, participation need not be so limited. The mere presence of the polypeptide in the membrane may alter the structure or properties of the membrane sufficiently to allow a proton, for example, to be transported from a relatively high proton concentration to a relatively low proton concentration on the other side of the membrane. This is not exclusively a passive, non-selective process such as might result from the use of non-selective, passive pore formers or from simple diffusion. Indeed, in some cases, inactivation of the polypeptides in a membrane provides results that are inferior to similar membranes made without polypeptides at all. These processes (excluding passive diffusion) are collectively referred to as “polypeptide mediated transport” where the presence of the polypeptide plays a role in the transporting of a species across the membrane, in ways other than merely structurally providing a static channel. Stated another way, “polypeptide mediated transport” means that the presence of the polypeptide results in effective transport from one side of the membrane to the other in response to something other than just concentration. “Participate,” in the context of a redox reaction, means that the polypeptide causes or facilitates the oxidation and/or reduction of a species, or conveys to or from that reaction protons, electrons or oxidized or reduced species.

“Polypeptide(s)” includes at least one molecule composed of four or more amino acids that is capable of participating in a chemical reaction, often as a catalyst, or participating in the transporting of a molecule, atom, proton or electron from one side of a membrane to another, or participating in the formation of molecular structures that facilitate or enable such reactions or transport. The polypeptide can be single stranded, multiple stranded, can exist in a single subunit or multiple subunits. It can be made up of exclusively amino acids or combinations of amino acids and other molecules. This can include, for example, pegalated peptides, peptide nucleic acids, peptide mimetics, neucleoprotein complexes. Strands of amino acids that include such modifications as glycosolation are also contemplated. Polypeptides in accordance with the present invention are generally biological molecules or derivatives or conjugates of biological molecules. Polypeptides can therefore include molecules that can be isolated, as well as molecules that can be produced by recombinant technology or which must be, in whole or in part, chemically synthesized. The term therefore encompasses naturally occurring proteins and enzymes, mutants of same, derivatives and conjugates of same, as well as wholly synthetic amino acid sequences and derivatives and conjugates thereof. In one preferred embodiment, polypeptides in accordance with the present invention can participate in the transporting of molecules, atoms, protons and/or electrons from one side of a membrane to another side thereof, can participate in oxidation or reduction, or are charge driven proton pumping polypeptides such as DH⁻ Complex I (also referred to as “Complex 1”).

The present invention stems from the recognition that it is possible to create biocompatible membranes using a wide range of synthetic polymer materials and polypeptides that permit the flow of positive charge, but are generally impervious to the flow of metals and in particular, metal cations. This allows the production of fuel cells using metal anodes that have one or more advantages. The membranes of the fuel cells retard plating of the cathode. In addition, the membranes only transfer positive charge in response to a charge imbalance, and therefore fuel cells made using said membranes do not consume fuel when the device they are powering is ‘off’. As aluminum and zinc both have higher standard potentials than, say, methanol, (nominally 2.31 volts and 1.29 volts versus 1.0 volts, respectively) less stacking of individual cells is required to obtain operational voltages. Both aluminum and zinc are also more energy dense than methanol, with 18.6 and 7.5 Watt-hours per milliliter, versus 3.97 Watt-hours per ml for methanol. Thus, although slightly heavier per unit volume, these metals are preferred for fuels for small electronic devices where size is of greater importance than mass.

Biocompatible membranes will facilitate the passage of current to a degree at least greater than that which would occur using the identical membrane without a polypeptide. Preferably, the biocompatible membranes of the present invention will provide at least about 10 picoamps/cm² (such as when the biocompatible membrane is used in a sensor) more preferably at least about 10 milliamps/cm² and even more preferably about 100 milliamps/cm² or more.

These biocompatible membranes are also generally, but not exclusively, free-standing as a membrane in air and thus can be at least partially desolvated. When used in a fuel cell, these biocompatible membranes will have a useful operating life of, preferably, at least 8 hours, more preferably, at least 3 days, and even more preferably one month or more, and still more preferably, six months or more.

Synthetic polymer membranes that are biocompatible and contain polypeptides capable of participating in a redox reaction and/or participating in the transport of a molecule, atom, proton or electron from one side of the membrane to the other are particularly advantageous because they can be used in the creation of a wide range of batteries or fuel cells. These include batteries that are environmentally friendly, light, compact and easily transportable. It is also possible to produce fuel cells that are very high in terms of power output. Preferably, a fuel cell produced in accordance with the present invention can generate at least 10 milliwatts/cm², preferably at least about 50 milliwatts/cm² and most preferably at least about 100 milliwatts/cm² when a circuit, usually with a load or resistance, is created between the anode and cathode. This is also referred to as being in electrical contact.

Fuel cells of the present invention include an anode compartment having an anode and a cathode compartment having a cathode. The fuel cell also includes at least one biocompatible membrane that facilitates the transfer of positive charge but not metals or metallic ions. The biocompatible membrane can be disposed within the anode compartment, within the cathode compartment or between the anode and cathode compartments. The biocompatible membrane, as previously discussed, can include at least one layer of a synthetic polymer material and at least one polypeptide associated therewith. Preferably, the polypeptide has the ability to participate in the transporting of molecules, atoms, protons or electrons from one side of the membrane to the other. Such a fuel cell may also include an electron carrier and a second polypeptide, both of which are disposed within the anode compartment.

### BRIEF DESCRIPTION OF THE DRAWINGS

FIG. 1 illustrates a fuel cell in accordance with the present invention.

FIG. 2a is an embodiment of a membrane in accordance with the present invention illustrated schematically as disposed within perforations contained in a dielectric substrate.

FIG. 2b is a second embodiment of a membrane in accordance with the present invention illustrated schematically as disposed within perforations contained in a dielectric substrate.

FIG. 3a is a cross-sectional view of an aperture having a beveled edge and a biocompatible membrane

FIG. 3b is a cross-sectional view of an aperture having a beveled edge and a biocompatible membrane

FIG. 3c is a cross-sectional view of an aperture having a beveled edge and a biocompatible membrane

### BEST MODE FOR CARRYING OUT INVENTION

Biocompatible membranes in accordance with the present invention can be formed from any synthetic polymer material that, when associated with one or more polypeptides as described herein, meet the objectives of the present invention.

Synthetic polymer materials can include polymers, copolymers and block copolymers and mixtures of same. These can be bound, crosslinked, functionalized or otherwise associated with one another. “Functionalized” means that the polymers, copolymers and/or block copolymers have been modified with end groups that are selected to perform a specific function, whether that be polymerization (crosslinking of blocks, for example), anchoring to a particular surface chemistry (use of, for example, certain sulfur linkages), facilitated electron transport via covalently linking an electron carrier or electron transfer mediator, and the like known to the art. Typically, these end groups are not considered a constituent of the polymer or block itself and are often added at the end of or after synthesis. Synthetic polymer materials are generally present on the finished membrane (the membrane in condition for use) in an amount of at least about 50% by weight of the finished membrane, more typically at least about 60% by weight of the finished membrane and often between about 70 and about as much as 99% by weight thereof. A portion of the total amount of the synthetic polymer material may be a stabilizing polymer, generally up to about a third, by weight based on the weight of the total synthetic polymer material in the finished biocompatible membrane.

The biocompatible membranes of the invention are preferably produced from one or more block copolymers such as A-B, A-B-A or A-B-C block copolymers, with or without other synthetic polymer materials such as polymers or copolymers, and with or without additives.

One suitable block copolymer is described in a series of articles by Corinne Nardin, Wolfgang Meier and others. Angew Chem Int. Ed. 39: 4599-4602, 2000; Langmuir 16: 1035-1041, 2000; Langmuir 16: 7708-7712, 2000. The functionalized poly (2-methyloxazoline)-block-poly (dimethylsiloxane)-block-poly(2-methyloxazoline) triblock copolymer described is as follows:

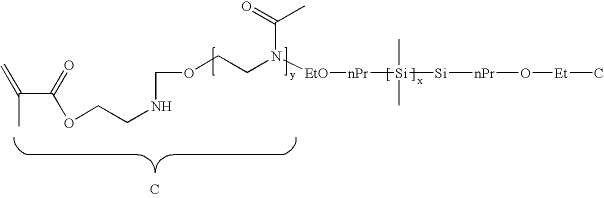

In the above chemical formula, the average x value is 68, and the average y value is 15. This is an A-B-A block copolymer in which the “C” recited in the formula does not necessarily equate with the “C” designation of an A-B-C block copolymer.

The polymer illustrated above can provide relatively large membranes that can incorporate functional proteins. The methacrylate moieties at the ends of the polymer molecules allow for free-radical mediated crosslinking after incorporating protein to add greater mechanical stability. Biocompatible membranes such as this, particularly those that are nonionic, have greater stability to higher voltage differences between the anode and cathode.

The functionalized poly(2-methyloxazoline)-block-poly(dimethylsiloxane)-block-poly(2-methyloxazoline)triblock copolymer discussed above is one example of a synthetic polymer material that can be used. Other exemplary block copolymers include, without limitation: Amphiphilic block copolymers [The triblock copolymer shells of the vesicles can be regarded as a mimetic of biological membranes although they are 2 to 3 times thicker than a conventional lipid bilayer. Nevertheless, they can serve as a matrix for membrane-integral proteins. Surprisingly, the proteins remain functional despite the extreme thickness of the membranes and even after polymerization of the reactive triblock copolymers.]; Triblock copolyampholytes from 5-(N,N-dimethylamino)isoprene, styrene, and methacrylic acid [Bieringer et al., Eur. Phys. J. E. 5:5-12, 2001. Among such polymers are Ai₁₄S₆₃A₂₃, Ai₃₁S₂₃A₄₆, Ai₄₂S₂₃A₃₅, Ai₅₆S₂₃A₂₁, Ai₅₇S₁₁A₃₂]; Styrene-ethylene/butylene-styrene triblock copolymer [(KRATON) G 1650, a 29% styrene, 8000 solution viscosity (25 wt-% polymer), 100% triblock styrene-ethylene/butylene-styrene (S-EB-S) block copolymer; (KRATON) G 1652, a 29% styrene, 1350 solution viscosity (25 wt-% polymer), 100% triblock S-EB-S block copolymer; (KRATON) G 1657, a 4200 solution viscosity (25 wt-% polymer), 35% diblock S-EB-S block copolymer; all available from the Shell Chemical Company. The preferred block copolymers are of the styrene-ethylene/propylene (S-EP) types and are commercially available under the tradenames (KRATON) G 1726, a 28% styrene, 200 solution viscosity (25 wt-% polymer), 70% diblock S-EB-S block copolymer; (KRATON) G-1701X a 37% styrene,>50,000 solution viscosity, 100% diblock S-EP block copolymer; and (KRATON) G-1702X, a 28% styrene,>50,000 solution viscosity, 100% diblock S-EP block copolymer also available from the Shell Chemical Company, Houston, Tex., USA]; Siloxane triblock copolymer [Nitrile containing siloxane block copolymers were developed as stabilizers for siloxane magnetic fluids. The siloxane magnetic fluids have been recently proposed as internal tamponades for retinal detachment surgery. PDMS-b-PCPMS-b-PDMSs (PDMS=polydimethylsiloxane, PCPMS=poly(3-cyanopropylmethyl-cyclosiloxane) were successfully prepared through kinetically controlled polymerization of hexamethylcyclotrisiloxane initiated by lithium silanolate endcapped PCPMS macroinitiators. The macroinitiators were prepared by equilibrating mixtures of 3-cyanopropylmethylcyclosiloxanes (DxCN) and dilithium diphenylsilanediolate (DLDPS). DxCNs were synthesized by hydrolysis of 3-cyanopropylmethyldichlorosilane, followed by cyclization and equilibration of the resultant hydrolysates. DLDPS was prepared by deprotonation of diphenylsilanediol with diphenylmethyllithium. It was found that mixtures of DxCN and DLDPS could be equilibrated at 100° C. within 5-10 hours. By controlling the DxCN-to-DLDPS ratio, macroinitiators of different molecular weights could be obtained. The major cyclics in the macroinitiator equilibrate are tetramer (8.6±0.7 wt %), pentamer (6.3±0.8 wt %) and hexamer (2.1±0.5 wt %). 2.5 k-2.5 k-2.5 k, 4 k-4 k-4 k, and 8 k-8 k-8 k triblock copolymers were prepared and characterized. These triblock copolymers are transparent, microphase separated and highly viscous liquids. It was found that these triblock copolymers can stabilize nanometer gamma-Fe2O3 and cobalt particles in octamethylcyclotetrasiloxane or hexane. Hence PDMS-b-PCPMS-b-PDMSs represent a class of promising steric stabilizers for silicone magnetic fluids.]; DEO-CPPO-CPEO triblock copolymer; PEO-PDMS-PEO triblock copolymer [Polyethylene oxide (PEO) is soluble in the aqueous phase, while the poly-dimethyl siloxane (PDMS) is soluble in oil phase]; PLA-PEG-PLA triblock copolymer; Poly(styrene-b-butadiene-b-styrene) triblock copolymer [Commonly used thermoplastic elastomers, includes Styrolux from BASF, Ludwigshafen, Germany]; Poly(ethylene oxide)/poly(propylene oxide) triblock copolymer films [Pluronic F127, Pluronic P105, or Pluronic L44 from BASF, Ludwigshafen, Germany]; Poly(ethylene glycol)-poly(propylene glycol) triblock copolymer; PDMS-PCPMS-PDMS (polydimethylsiloxane-polycyanopropylmethylsiloxane) triblock copolymer [A series of epoxy and vinyl endcapped polysiloxane triblock copolymers with systematically varied molecular weights were synthesized via anionic polymerization using LiOH as an initiator. The nitrile groups on the central copolymer block are thought to adsorb onto the particle surfaces, while the PDMS endblocks protrude into the reaction medium.]; Azo-functional styrene-butadiene-HEMA triblock copolymer, Amphiphilic triblock copolymer carrying polymerizable end groups; Syndiotactic polymethylmethacrylate (sPMMA)-polybutadiene (PBD)-sPMMA triblock copolymer, Tertiary amine methacrylate triblock [AB diblock copolymer which can form both micelles (B block in the core) and reverse micelles (A block in the core) in water at 20° C.]; Biodegradable PLGA-b-PEO-b-PLGA triblock copolymer; Polyactide-b-polyisoprene-b-polyactide triblock copolymer; PEO-PPO-PEO triblock copolymer [Same as Pluronic from BASF]; Poly(isoprene-block-styrene-block-dimethylsiloxane) triblock copolymer; Poly(ethylene oxide)-block-polystyrene-block-poly(ethylene oxide) triblock copolymer; Poly(ethylene oxide)-poly(THF)-poly(ethylene oxide) triblock copolymer; Ethylene oxide triblock; Poly E-caprolactone [Birmingham Polymers]; Poly(DL-lactide-co-glycolide) [Birmingham Polymers]; Poly(DL-lactide) [Birmingham Polymers]; Poly(L-lactide) [Birmingham Polymers]; Poly(glycolide) [Birmingham Polymers]; Poly(DL-lactide-co-caprolactone) [Birmingham Polymers]; Styrene-Isoprene-styrene triblock copolymer [Japan Synthetic Rubber Co., MW=140 kg/mol, Block ratio of PS/PI=15/85]; PEO/PPO triblock copolymer; PMMA-b-PIB-b-PMMA [linear triblock TPE]; PLGA-block-PEO-block-PLGA triblock copolymer [Sulfonated styrene/ethylene-butylene/styrene (S-SEBS) TBC polymer proton conducting membrane. Available as Protolyte A700 from Dais Analytic, Odessa Fla.]; Poly(1-lactide)-block-poly(ethylene oxide)-block-poly(1-lactide) triblock copolymer; Poly-ester-ester-ester triblock copolymer; PLA/PEO/PLA triblock copolymer [The synthesis of the triblock copolymers will be prepared by ring-opening polymerization of DL-lactide or e-caprolactone in the presence of poly(ethylene glycol), using non-toxic Zn metal or calcium hydride as co-initiator instead of the stannous octoate. The composition of the copolymers will be varied by adjusting the polyester/polyether ratio.]; PCC/PEO/PCC triblock copolymer [The above polymers can be used in mixtures of two or more. For example, in two polymer mixtures measured in weight percent of the first polymer, such mixtures can comprise 20-25%, 25-30%, 30-35%, 35-40%, 40-45% or 45-50%.]; Poly(t-butyl acrylate-b-methyl methacrylate-b-t-butyl acrylate) [Polymer Source, Inc., Dorval, Quebec, Canada]; Poly(t-butyl acrylate-b-styrene-b-t-butyl acrylate) [Polymer Source, Inc.]; Poly(t-butyl methacrylate-b-t-butyl acrylate-b-t-butyl methacrylate) [Polymer Source, Inc.]; Poly(t-butyl methacrylate-b-methyl methacrylate-b-t-butyl methacrylate) [Polymer Source, Inc.]; Poly(t-butyl methacrylate-b-styrene-b-t-butyl methacrylate) [Polymer Source, Inc.]; Poly(methyl methacrylate-b-butadiene(1,4 addition)-b-methyl methacrylate) [Polymer Source, Inc.]; Poly(methyl methacrylate-b-n-butyl acrylate-b-methyl methacrylate) [Polymer Source, Inc.]; Poly(methyl methacrylate-b-t-butyl acrylate-b-methyl methacrylate) [Polymer Source, Inc.]; Poly(methyl methacrylate-b-t-butyl methacrylate-b-methyl methacrylate) [Polymer Source, Inc.]; Poly(methyl methacrylate-b-dimethylsiloxane-b-methyl methacrylate) [Polymer Source, Inc.]; Poly(methyl methacrylate-b-styrene-b-methyl methacrylate) [Polymer Source, Inc.]; Poly(methyl methacrylate-b-2-vinyl pyridine-b-methyl methacrylate) [Polymer Source, Inc.]; Poly(butadiene(1,2 addition)-b-styrene-b-butadiene(1,2 addition)) [Polymer Source, Inc.]; Poly(butadiene(1,4 addition)-b-styrene-b-butadiene(1,4 addition)) [Polymer Source, Inc.]; Poly(ethylene oxide-b-propylene oxide-b-ethylene oxide) [Polymer Source, Inc.]; Poly(ethylene oxide-b-styrene-b-ethylene oxide) [Polymer Source, Inc.]; Poly(lactide-b-ethylene oxide-b-lactide) [Polymer Source, Inc.]; Poly(lactone-b-ethylene oxide-b-lactone) [Polymer Source, Inc.]; a, w-Diacrylonyl Terminated poly(lactide-b-ethylene oxide-b-lactide) [Polymer Source, Inc.]; Poly(styrene-b-acrylic acid-b-styrene) [Polymer Source, Inc.]; Poly(styrene-b-butadiene(1,4 addition)-b-styrene) [Polymer Source, Inc.]; Poly(styrene-b-butylene-b-styrene) [Polymer Source, Inc.]; Poly(styrene-b-n-butyl acrylate-b-styrene) [Polymer Source, Inc.]; Poly(styrene-b-t-butyl acrylate-b-styrene) [Polymer Source, Inc.]; Poly(styrene-b-ethyl acrylate-b-styrene) [Polymer Source, Inc.]; Poly(styrene-b-ethylene-b-styrene) [Polymer Source, Inc.]; Poly(styrene-b-isoprene-b-styrene) [Polymer Source, Inc.]; Poly(styrene-b-ethylene oxide-b-styrene) [Polymer Source, Inc.]; Poly(2-vinyl pyridine-b-t-butyl acrylate-b-2-vinyl pyridine) [Polymer Source, Inc.]; Poly(2 vinyl pyridine-b-butadiene(1,2 addition)-b-2-vinyl pyridine) [Polymer Source, Inc.]; Poly(2-vinyl pyridine-b-styrene-b-2-vinyl pyridine) [Polymer Source, Inc.]; Poly(4-vinyl pyridine-b-t-butyl acrylate-b-4-vinyl pyridine) [Polymer Source, Inc.]; Poly(4-vinyl pyridine-b-methyl methacrylate-b-4-vinyl pyridine) [Polymer Source, Inc.]; Poly(4-vinyl pyridine-b-styrene-b-4-vinyl pyridine) [Polymer Source, Inc.]; Poly(butadiene-b-styrene-b-methyl methacrylate) [Polymer Source, Inc.]; Poly(styrene-b-acrylic acid-b-methyl methacrylate) [Polymer Source, Inc.]; Poly(styrene-b-butadiene-b-methyl methacrylate) [Polymer Source, Inc.]; Poly(styrene-b-butadiene-b-2-vinyl pyridine) [Polymer Source, Inc.]; Poly(styrene-b-butadiene-b-4-vinyl pyridine) [Polymer Source, Inc.]; Poly(styrene-b-t-butyl methacrylate-b-2-vinyl pyridine) [Polymer Source, Inc.]; Poly(styrene-b-t-butyl methacrylate-b-4-vinyl pyridine) [Polymer Source, Inc.]; Poly(styrene-b-isoprene-b-glycidyl methacrylate) [Polymer Source, Inc.]; Poly(styrene-b-a-methyl styrene-b-t-butyl acrylate) [Polymer Source, Inc.]; Poly(styrene-b-a-methyl styrene-b-methyl methacrylate) [Polymer Source, Inc.]; Poly(styrene-b-2-vinyl pyridine-b-ethylene oxide) [Polymer Source, Inc.]; Poly(styrene-b-2-vinyl pyridine-b-4-vinyl pyridine) [Polymer Source, Inc.].

The above block copolymers can be used alone or in mixtures of two or more in the same or different classes. For example, in mixtures of two block copolymers measured in weight percent of the first polymer, such mixtures can comprise 10-15%, 15-20%, 20-25%, 25-30%, 30-35%, 35-40%, 40-45% or 45-50%. Where three polymers are used, the first can comprise 10-15%, 15-20%, 20-25%, 25-30%, 30-35%, 35-40%, 40-45% or 45-50% of the whole of the polymer components, and the second can 10-15%, 15-20%, 20-25%, 25-30%, 30-35%, 35-40%, 40-45% or 45-50% of the remainder.

Stated another way, the amount of each block copolymer in a mixture can vary considerably with the nature and number of the block copolymers used and the desired properties to be obtained. However, generally, each block copolymer of a mixture in accordance with the present invention will be present in an amount of at least about 10% based on weight of total polymers in the membrane or solution. These same general ranges would apply to membranes produced from one or more polymers, copolymers and/or mixtures with block copolymers. There may also be instances where a single polymer, copolymer or block copolymer may be “doped” with a small amount of a distinct polymer, copolymer or block copolymer, even as little as 1.0% by weight of the membrane to adjust the membrane's specific properties.

Embodiments of the invention include, without limitation, A-B, A-B-A or A-B-C block copolymers. The average molecular weight for triblock copolymers of A (or C) is, for example, 1,000 to 15,000 daltons, and the average molecular weight of B is 1,000 to 20,000 daltons. More preferably, block A and/or C will have an average molecular weight of about 2,000-10,000 Daltons and block B will have an average molecular weight of about 2,000-10,000 daltons.

If a diblock copolymer is used, the average molecular weight for A is between about 1,000 to 20,000 Daltons, more preferably, about 2,000-15,000 Daltons. The average molecular weight of B is between about 1,000 to 20,000 Daltons, more preferably about 2,000 to 15,000 Daltons.

Preferably, the block copolymer will have a hydrophobic/hydrophilic balance that is selected to (i) provide a solid at the anticipated operating and storage temperature and (ii) promote the formation of biomembrane-like structures rather than micelles. More preferably, the hydrophobic content (or block) shall exceed the hydrophilic content (or block). Thus, at least one block of the diblock or triblock copolymers is preferably hydrophobic. While wettable membranes are possible, preferably the content of hydrophobic and hydrophilic synthetic polymeric materials will render the membrane sparingly wettable.

As described above, in one preferred embodiment of the present invention, there is provided a biocompatible membrane produced using a mixture of synthetic polymer materials. Such mixtures can be a mixture of two or more block copolymers that are identical but for the molecular weight of their respective blocks. For example, a biocompatible membrane can be produced using a mixture of two block copolymers, both of which are poly(2-methloxazoline)-polydimethylsiloxane-poly(2-methloxazoline), one of which having an average molecular weight of 2 kD-5 kD-2 kD and the other 3 kD-7 kD-3 kD and the ratio of the first block copolymer to the second is about 67% to 33% of the total synthetic polymer material used w/w. This, of course means that the majority block copolymer's first block has a molecular weight of about 2 thousand Daltons, the second block has a molecular weight of 5 thousand Daltons and the third block has a molecular weight of 2 thousand Daltons. The minority block copolymer has blocks of about 3 thousand, 7 thousand and 3 thousand Daltons respectively.

Of course, two or more entirely different block copolymers can be used and mixtures of different block copolymers and identical block copolymers that differ only in the size of their respective blocks are also contemplated. But mixtures are not limited to block copolymers.

Polymers and copolymers can be used, alone, in combination, and in combination with block copolymers in accordance with the present invention to produce biocompatible membranes having the properties described herein. Polymers and copolymers useful are preferably solid at room temperature (25° C.). They can be dissolved in solvents or solvent systems that can accommodate any other synthetic polymer material used, any additive used, and the polypeptide used. Polymers and copolymers useful in producing biocompatible membranes can include, without limitation polystyrenes, polyalkyl and polydialkyl siloxanes such as polydimethylsiloxane, polyacrylates such as polymethylmethacrylate, polyalkenes such as polybutadiene, polyalkylenes and polyalkylene glycols, sulfonated polystyrene, polydienes, polyoxiranes, poly(vinyl pyridines), polyolefins, polyolefin/alkylene vinyl alcohol copolymers, ethylene propylene copolymers, ethylene-butene-propylene copolymers, ethyl vinyl alcohol copolymers, perfluorinated sulfonic acids, vinyl halogen polymers and copolymers such as copolymers of vinyl chloride and acrylonitrile, methacrylic/ethylene copolymers and other soluble but generally hydrophobic polymers and copolymers all in a molecular weight of between about 5,000 and about 500,000. Particularly preferred polymers include: Poly(n-butyl acrylate); Poly(t-butyl acrylate); Poly(ethyl acrylate); Poly(2-ethyl hexyl acrylate); Poly(hydroxy propyl acrylate); Poly(methyl acrylate); Poly(n-butyl methacrylate); Poly(s-butyl methacrylate); Poly(t-butyl methacrylate); Poly(ethyl methacrylate); Poly(glycidyl methacrylate); Poly(2-hydroxypropyl methacrylate); Poly(methyl methacrylate) Poly(n-nonyl methacrylate); Poly(octadecyl methacrylate); Polybutadiene (1,4-addition); Polybutadiene (1,2-addition); Polyisoprene (1,4-addition); Polyisoprene (1,2-addition and 1,4 addition); Polyethylene; Poly(dimethyl siloxane); Poly(ethyl methyl siloxane); Poly(phenyl methyl siloxane); Polypropylene; Poly(propylene oxide); Poly(4-acetoxy styrene); Poly(4-bromo styrene); Poly(4-t-butyl styrene); Poly(4-chlorostyrene); Poly(4-hydroxyl styrene); Poly(a-methyl styrene); Poly(4-methyl styrene); Poly(4-methoxy styrene); Polystyrene; Isotactic Polystyrene; Syndiotactic Polystyrene; Poly(2-vinyl pyridine); Poly(4-vinyl pyridine); Poly(2,6-dimethyl-p-phenylene oxide); Poly(3-(hexafluoro-2-hydroxypropyl)-styrene); Polyisobutylene; Poly(9-vinyl anthracene); Poly(4-vinyl benzoic acid); Poly(4-vinyl benzoic acid sodium salt); Poly(vinyl benzyl chloride); Poly(3(4)-vinyl benzyl tetrahydrofurfuryl ether); Poly(N-vinyl carbazole); Poly(2-vinyl naphthalene) and Poly(9-vinyl phenanthrene). Since polymers and copolymers are generally synthetic polymer materials, they may be used in the same amounts described previously for block copolymers and mixtures.

In some embodiments of the present invention, the biocompatible membrane includes a synthetic polymer material, preferably at least one block copolymer and a synthetic polymer material that can stabilize or enhance the longevity or functionality of the biocompatible membrane. It has been discovered that certain polymers, most notably, hydrophilic polymers and copolymers capable of forming a plurality of hydrogen-bonds (“hydrogen bonding rich”) can stabilize the membrane. In the context of stabilizing polymers, the term “polymer” includes monomers, polymers and copolymers. “Hydrophilic” in this context means that the stabilizing polymer will dissolve or be solubilized in water or water miscible solvents. Without wishing to be bound to any particular theory of operation, it is believed that the use of such polymers imparts to a biocompatible membrane greater operating life and/or greater resistance to mechanical failure when compared to an identical biocompatible membrane produced without the stabilizing polymer when exposed to the same conditions. Such polymers may also aid in the maintenance of polypeptides in an active form, or in the maintenance of an environment which promotes their function. A stabilized biocompatible membrane wherein the synthetic polymer material includes a stabilizing polymer, used in a fuel cell, for example, can have an increased operating life of at least about 10%, more preferably at least about 50%, most preferably at least about 100%.

Particularly preferred polymers capable of stabilizing the polypeptides in the biocompatible membranes of the present invention include: dextrans, polyalkylene glycols, polyalkylene oxides, polyacrylamides, and polyalkyleneamines. These stabilized polymers (again including copolymers) have an average molecular weight which is generally lower than polymers and copolymers used as synthetic polymer materials. Their molecular weight generally ranges from about 1,000 daltons to about 15,000 daltons. Particularly preferred polymers capable of stabilizing biocompatible membranes include, without limitation, polyethylene glycol having an average molecular weight of between about 2,000 and about 10,000, polyethylene oxide having an average molecular weight of between about 2,000 and about 10,000, poly acrylamide having an average molecular weight of between about 5,000 and 15,000 daltons. Other stabilizing polymers include: polypropylene, Poly(n-butyl acrylate); Poly(t-butyl acrylate); Poly(ethyl acrylate); Poly(2-ethyl hexyl acrylate); Poly(hydroxy propyl acrylate); Poly(methyl acrylate); Poly(n-butyl methacrylate); Poly(s-butyl methacrylate); Poly(t-butyl methacrylate); Poly(ethyl methacrylate); Poly(glycidyl methacrylate); Poly(2-hydroxypropyl methacrylate); Poly(methyl methacrylate); Poly(n-nonyl methacrylate); and Poly(octadecyl methacrylate).

The amount of stabilizing polymer(s) used in the biocompatible membranes is not critical so long as some measurable improvement in properties is realized and the functionality of the biocompatible membrane is not unduly hampered. Some trade of functionality and longevity is to be expected. However, generally, the amount of stabilizing polymer used, as a function of the total amount of synthetic polymer material found in the finished biocompatible membrane (by weight) is generally not more than one-third, and typically 30% by weight or less. Preferably, the amount used is between 5 and about 30%, more preferably between about 5 and about 15% by weight of the synthetic polymer material in the finished membrane is used.

In addition to one or more polymers, copolymers and/or block copolymers, and/or stabilized polymers, the synthetic polymer material of the invention can include at least one additive. Additives can include crosslinking agents and lipids, fatty acids, sterols and other natural biological membrane components and their synthetic analogs. These are generally added to the synthetic polymer material when in solution. These additives, if present at all, generally would be found in an amount of between about 0.50% and about 30%, preferably between about 1.0% and about 15%, based on the weight of the synthetic polymer material.

Where the biocompatible membrane incorporates cross-linking moieties, procedures useful for polymerization include chemical polymerization with radical-forming or propagating agents and polymerization via photochemical radical generation with or without further radical propagating agents. Parameters can be adjusted depending on such conditions as the membrane material, the size of biocompatible membrane segments, the structure of the support, and the like. Care should be taken to minimize the damage to the polypeptide. One particularly useful method involves using peroxide at a neutral pH, followed by acidification.

Examples of useful polypeptides that can be associated with a synthetic polymer material, so as to form a biocompatible membrane in accordance with the present invention, and that can participate in one or both of the oxidation/reduction and transmembrane transport functions (molecules, atoms, protons, electrons) include, for example, NADH dehydrogenase (“complex I”) (e.g., from E. coli. Tran et al., “Requirement for the proton pumping NADH dehydrogenase I of Escherichia coli in respiration of NADH to fumarate and its bioenergetic implications,” Eur. J. Biochem. 244: 155, 1997), NADPH transhydrogenase, proton ATPase, and cytochrome oxidase and its various forms. Further polypeptides include: glucose oxidase (using NADH, available from several sources, including number of types of this enzyme available from Sigma Chemical), glucose-6-phosphate dehydrogenase (NADPH, Boehringer Mannheim, Indianapolis, Ind.), 6-phosphogluconate dehydrogenase (NADPH, Boehringer Mannheim), malate dehydrogenase (NADH, Boehringer Mannheim), glyceraldehyde-3-phosphate dehydrogenase (NADH, Sigma, Boehringer Mannheim), isocitrate dehydrogenase (NADH, Boehringer Mannheim; NADPH, Sigma), α-ketoglutarate dehydrogenase complex (NADH, Sigma) and proton-translocating pyrophosphates. Also included are succinate:quinone oxidoreductase, also referred to as “Complex II,” “A structural model for the membrane-integral domain of succinate:quinone oxidoreductases” Hagerhall, C. and Hederstedt, L., FEBS Letters 389; 25-31 (1996) and “Purification, crystallisation and preliminary crystallographic studies of succinate:ubiquinone oxidoreductase from Escherichia coli.” Tornroth, S., et al., Biochim. Biophys. Acta 1553; 171-176 (2002), heterodisulfide reductases, F(420)H(2) dehydrogenase, (Baumer et al., “The F420H2 dehydrogenase from Methanosarcina mazei is a Redox-driven proton pump closely related to NADH dehydrogenases.”275 J. Biol. Chem. 17968 (2000)) or a formate hydrogenlyase (Andrews, et al., A 12-cistron Escherichia coli operon (hyf) encoding a putative proton-translocating formate hydrogenlyase system.” 143 Microbiology 3633 (1997)), Nicotinamide nucleotide transhydrogenases: “Nicotinamide nucleotide transhydrogenase: a model for utilization of substrate binding energy for proton translocation.” Hatefi, Y. and Yamaguchi, M., Faseb J., 10; 444-452 (1996), Proline Dehydrogenase: “Proline Dehydrogenase from Escherichia coli K12.” Graham, S., et al., J. Biol. Chem. 259; 2656-2661 (1984), and Cytochromes including, without limitation, cytochrome C oxidase (crystallized with either undecyl-β-D-maltoside or cyclohexyl-hexyl-β-D-maltoside), Cytochrome bc₁: “Ubiquinone at Center N is responsible for triphasic reduction of cytochrome bc₁ complex.” Snyder, C. H., and Trumpower, B. L., J. Biol. Chem. 274; 31209-16 (1999), Cytochrome bo₃: “Oxygen reaction and proton uptake in helix VIII mutants of cytochrome bo₃.” Svensson, M., et al., Biochemistry 34; 5252-58 (1995), “Thermodynamics of electron transfer in Escherichia coli cytochrome bo₃.” Schultz, B. E., and Chan, S. I., Proc. Natl. Acad. Sci. USA 95; 11643-48 (1998), and Cytochrome d: “Reconstitution of the Membrane-bound, ubiquinone-dependent pyruvate oxidase respiratory chain of Escherichia coli with the cytochrome d terminal oxidase.” Koland, J. G., et al., Biochemistry 23; 445-453 (1984), Joost and Thorens, “The extended GLUT-family of sugar/polyol transport facilitators: nomenclature, sequence characteristics, and potential function of its novel members (review)” 18 Mol. Membr. Biol. 247-56 (2001), and selective channel proteins including those disclosed in Goldin, A. L., “Evolution of voltage-gated Na(+) channels.” J. Exp. Biol. 205; 575-84 (2002), Choe, S., “Potassium channel structures.” Nat. Rev. Neurosci. 3;115-21 (2002), Dimroth, P., “Bacterial sodium ion-coupled energetics.” Antonie Van Leeuwenhoek 65; 381-95 (1994), and Park, J. H. and Saier, M. H. Jr., “Phylogenetic, structural and functional characteristics of the Na—K—Cl cotransporter family.” J. Membr. Biol. 149; 161-8 (1996). All of the foregoing are hereby incorporated by reference. Methods of isolating such an NADH dehydrogenase enzyme are described in detail, for example, in Braun et al., Biochemistry 37: 1861-1867, 1998; and Bergsma et al., “Purification and characterization of NADH dehydrogenase from Bacillus subtilis,” Eur. J. Biochem. 128: 151-157, 1982. As described by Spehr et al., Biochemistry 38:16261-16267, 1999, the complex I NADH dehydrogenase (or, NADH:ubiquinone oxidoreductase), which is expressed from a operon, can be overexpressed in E. coli by substituting a T7 promoter in the operon to provide useful quantities for use in the invention. Complex I can be isolated from over-expressing E. coli by the method described by Spehr et al. using solubilization with dodecyl maltoside.

Complex I can be handled such that NADH dehydrogenase activity is eliminated or greatly reduced. As described in Böttcher et al., “A Novel, Enzymatically Active Conformation of the Escherichia coli NADH:Ubiquinone Oxidoreductase (Complex I)”, J. Biol. Chem. 277: 17970-7, (2002) in high salt or high pH solution Complex I changes conformation such that proton transport is uncoupled from NADH dehydrogenase activity, creating DH⁻ form. Applicants have used these conditions and combinations of these conditions to show that the fuel cell of the invention can operate without NADH dehydrogenase activity in the anode/cathode barrier. Such conditions include anolyte or anode salt concentrations of 200 mM to 2M, and pH of 8.0 or above. Transporter activity is believed to function against a countering [H⁺] gradient, due to the charge imbalance between the anode and cathode sides. Proton transporter activity of the DH⁻ form has been confirmed from the maintenance of current generation in fuel cells in which biocompatible membranes gated by this form provided the only avenue to relieve charge imbalance. (Note that with complex I reverse transport of protons has been further controlled against by using conditions on the cathode side that maintain the NADH dehydrogenase coupling of any inversely oriented complex I—thereby blocking reverse transport due to lack of NADH substrate.)

It will be recognized that the source of any enzyme used in the invention can be a thermophilic organism providing a more temperature stabile enzyme. For example, complex I can be isolated from Aquifex aeolicus in a form that operates optimally at 90° C., as described in Scheide et al., FEBS Letters 512: 80-84, 2002 (describing a preliminary isolation using the type of detergent extraction used elsewhere for complex I).

Additionally, it is contemplated that genetically modified polypeptides, such as modified enzymes, can be used. One commonly applied technique for genetically modifying an enzyme is to use recombinant tools (e.g., exonucleases) to delete N-terminal, C-terminal or internal sequence. These deletion products are created and tested systematically using ordinary experimentation. As is often the case, significant portions of the gene product can be found to have little effect on the commercial function of interest. More focused deletions and substitutions can increase stability, operating temperature, catalytic rate and/or solvent compatibility providing enzymes that can be used in the invention. Of course it is possible to use mixtures of various polypeptides described herein as may be desirable.

The amount of polypeptide used will vary with the type of polypeptide used, the nature and function of the biocompatible membrane, the environment in which it will be used, etc. The amount of polypeptide may be important to certain applications such as fuel cells where, in general, the higher the concentration of polypeptide per square centimeter of surface area, the higher the rate of proton transfer per unit area (in terms of current). In general, however, as long as some polypeptide is present and functional, and as long as the amount of polypeptide used does not prevent membrane formation or render the membrane unstable, then any amount of polypeptide is possible. Generally, the amount of polypeptide will be at least about 0.01%, more preferably about 5%, even more preferably 10%, and still more preferably at least about 20% and most preferably 30% or more by weight based on the final weight of the biocompatible membrane. The amount of polypeptide to solvent can be as low as 0.001% w/v and as high as 50.0% w/v. Preferably, the concentration is from about 0.5% to about 5.0% w/v. More preferably the concentration is from about 1.0% to about 3.0% w/v.

Suitable solubilizing and/or stabilizing agents such as cosolvents, detergents and the like may also be needed, particularly in connection with the polypeptide solution. Solubilizing detergents are commonly found at the 0.01% to 1.0% concentration level, and more preferably up to about 0.5% is contemplated. Such detergents include ionic detergents: Sodium dodecyl sulfate, Sodium N-dodecyl sarcosinate, N-dodecyl Beta-D-glucopyranoside, Octyl-Beta-D-glucopyranoside, dodecyl-maltoside, decyl, undecyl, tetradecyl-maltoside (in general, an alkyl chain of about 8 carbons or more bonded to a sugar as a general form of an ionic detergent) octyl-beta-D-glucoside and polyoxytheylane (9) dodecyl-ether, C₁₂E₉, as well as non-ionic detergents, such as triton X-100, or Nonidet P-40. Also useful are certain polymers, typically diblock copolymers which exhibit surfactant properties, such as BASF's Pluronic series, or Disperplast (BYK-Chemie).

The solvent used in producing the synthetic polymer material solution is preferably selected to be miscible with both the water used (the polypeptide solution often includes water) and at least one of the synthetic polymer materials (polymer, copolymer and/or block copolymer). However, as described above, it is possible to form membranes using solvents or mixtures which are not water miscible. Note that while the use of solvents to produce solutions is preferred, the term “solution” as used herein generally encompasses suspensions as well.

When a block copolymer is used, the solvent should solubilize these synthetic polymer materials. While the synthetic polymer material may be relatively sparingly soluble in the solvent (less than 5% w/v), it is preferably more soluble than 5% w/v and generally, solubility is at least 5 to 10% w/v, preferably greater than 10% w/v synthetic polymer material to solvent.

Appropriate solvents may include, without limitation, low molecular weight aliphatic alcohols and diols of between 1 and 12 carbons such as methanol, ethanol, 2-propanol, isopropanol, 1-propanol, aryl alcohols such as phenols, benzyl alcohols, low molecular weight aldehydes and ketones such as acetone, methyl ethyl ketone, cyclic compounds such as benzene, cyclohexane, toluene and tetrahydrofuran, halogenated solvents such as dichloromethane and chloroform, and common solvent materials such as 1,4-dioxane, normal alkanes (C₂-C₁₂) and water. Solvent mixtures are also possible as long as the mixture has the appropriate miscibility, rate of evaporation and the other criteria described for individual solvents. (Solvent components that have any tendency to form protein-destructive contaminants such as peroxides can be used as long as they can be appropriately purified and handled.) Solvent typically comprises 30% v/v or more of the polypeptide/synthetic polymer material solution, preferably 20% v/v or more, and usefully 10% v/v or more.

If the membranes are to include “other materials” such as detergents, lipids (e.g. cardiolipin), sterols (e.g. cholesterol) or buffers and/or salts, those too would be added prior to formation of the membrane and they would be present in an amount of between about 0.01 and about 30%, preferably between about 0.01 and about 15% based on the weight of the finished biocompatible membrane. Other materials, as opposed to additives, are most often mixed with the polypeptide solutions, not the synthetic polymer solutions.

The impermeability of the membrane to the ionic forms of the metallic anodes was assessed via mass spectrographic analysis of the catholyte of cells that had been operational for at least 12 hours. The amount of metallic ion present, or if none was detected, the detection limit, was compared to the current that had passed through the membrane over the time the cell was operational to determine a ratio of metallic ion to protons that passed the membrane. For some of the membranes described, this ratio was approximately 1/100, for at least one example, there was no detectable aluminum or zinc ion in the cathode, denoting impermeability to greater than 1/1000 metallic ions to protons.

Biocompatible membranes in accordance with the present invention can be produced using any one of a number of conventional techniques used in the production of membranes from synthetic polymer materials and even lipid bilayers, as long as the resulting biocompatible membranes are useful as described herein. One method of forming a biocompatible membrane, which is preferred for use with block copolymer-based membrane, is as follows:

1. Form a solution or suspension of synthetic polymer material in a solvent or mixed solvent system. The solution or suspension can be a mixture of two or more block copolymers, although it may contain one or more polymers and/or copolymers. The solution or suspension preferably contains 1 to 90% w/v synthetic polymer material, more preferably 2 to 70%, or yet more preferably 3 to 20% w/v. Seven % w/v is particularly preferred.

2. One or more polypeptides (typically with solubilizing detergent) are placed in solution or suspension, either separately or by being added to the existing polymer solution or suspension. Where the solvent used to solubilize the synthetic polymer materials is the same, or of similar characteristics and solubility to that which can solubilize the polypeptide, it is usually more convenient to add the polypeptide to the polymer solution or suspension directly. Otherwise, the two or more solutions or suspensions containing the synthetic polymer materials and the polypeptide must be mixed, possibly with an additional cosolvent or solubilizer. Most often, the solvent used for the polypeptide is aqueous.

Mixing of these solutions and/or suspensions is often a relatively simple matter and can be accomplished by hand or with automated mixing tools. Heating or cooling may also be useful in membrane formation depending on the solvents and polymers used. In general, rapidly evaporating solvents tend to form membranes better with cooling while extremely slowly evaporating solvents would most likely benefit from a slight degree of heating. One can examine the boiling point of solvents used to select those with the most favorable characteristics provided they are appropriate for the polymer used. One must, of course, however consider also the need to incorporate the polypeptide into the solvent polymer mixture, which can be a nontrivial matter. It is possible, for example, to mix 5 microliters of a detergent solubilized Complex I (0.15% w/v dodecyl maltoside) having 10 mg/ml of Complex I into 95 microliters of a mixture of a 3.2% w/v polystyrene-polybutadiene-polystyrene triblock copolymer (a completely hydrophobic triblock Sold under the trademark STYROLUX 3G55, Lot No. 7453064P, available from BASF in a 50/50 mixture of acetone and hexane and to deposit same in a manner that will allow for membrane formation. In this case, the final mixture included about 5% v/v of water, and 0.75% w/w Complex I relative to the weight of the synthetic polymer material. Generally, the solutions are sufficiently stable at room temperature to be useful for at least about 30 minutes, provided that the solvents do not evaporate during that time. They also can be stored overnight, or longer, generally under refrigerated conditions.

3. A volume of the final solution or suspension including both the polypeptide(s) and the synthetic polymer materials is formed into a membrane and allowed to at least partially dry, thereby removing at least a portion of the solvent. It is possible to completely dry some of the membranes produced in accordance with the invention or to substantially dry same. By substantially dry it is meant that there may be some residual solvent, up to about 15%, which is often retained even if left out at room temperature for several hours.

In a particularly preferred embodiment, substantially all of the weight of the finished membrane will be either polypeptide or synthetic polymer material. In this case, the amount of synthetic polymer material, including additives and stabilizing polymers ranges from about 70% to about 99% by weight of the finished membrane. However, it may be desirable to have an even greater polypeptide content or it may be necessary to retain some solvent, so the amount of synthetic polymer material may be reduced accordingly. Generally, however, at least about 50% by weight of the finished biocompatible membrane will be synthetic polymer material. When the synthetic polymer material is a mixture that includes a block copolymer and a polymer or copolymer, other than a stabilizing polymer, the block copolymer can be present in an amount of at least about 35% by weight of the biocompatible membrane. Up to about 30% by weight of the biocompatible membrane can be “additives” and “other materials” (collectively) as defined herein. More preferably the amount of additives and other materials is up to about 15% by weight of the biocompatible membrane. Up to about 30% by weight of the synthetic polymer material can be stabilizing polymer. Generally the stabilizing polymer will be present in an amount of between about 5 and about 20% of the weight of the synthetic polymer material used.

Identifying which solvents are particularly useful in accordance with the present invention and which combination of polymers and polypeptides and solvents should be used depends on a number of factors, some of which have already been discussed in terms of miscibility, evaporation and the like. The polymer and protein constituents must be able to be completely dissolved in the solvent or solvent mixture. Evaporation rate must be sufficiently long to allow one time to produce a membrane. However, the amount of time should not be so long as to render manufacturing impractical. While apolar solvents may be useful, generally more apolar solvents may not be useful in certain circumstances as ionic or hydroxyl components of the polymer may be poorly soluble in completely apolar solvents. Thus one may be able to dissolve a highly rigid, hydrophobic component such as polystyrene and be unable to simultaneously dissolve a highly ionic component such as an acrylic acid. However, with polymers of completely hydrophobic character, then apolar solvents are preferred. The solvents should generally be, in part, nonaqueous as the polymer should be at least in part nonwater dissolvable. And while water-miscibility is most desired for membrane protein reconstitution, it is not a rigidly limiting factor. Thus, preferably, all solvents are nonaqueous. The solvent for the polypeptide and stabilizing polymers, however, is predominantly water or at least water miscible.

Preferred methods of forming biocompatible membranes including both at least one synthetic polymer material and a stabilizing polymer include the step of making an appropriate solution of block copolymer and, usually separately stabilizing polymer and polypeptide. As described elsewhere, the polypeptide may include one or more detergents or surfactants and is typically in an aqueous solution. Once the appropriate solutions are made and mixed, membranes can be made by any of the techniques disclosed herein or known to the art including, for example, coating a perforated dielectric substrate with the solution followed by at least partial evaporation of solvents. Such evaporation can be facilitated in a vacuum.

One method of forming a biocompatible membrane, including a hydrogen-bonding rich stabilizing polymer, is as follows:

1. A solution or suspension of Protolyte A700 block copolymer in a solvent as supplied is diluted with an equal volume of ethanol (5% water w/v). The solution contains about 5% w/v of block copolymer.

2. Separately, an aqueous solution or suspension of the stabilizing agent is made by mixing 943 mg of polyethylene glycol (PEG) 8000 to produce a solution having a concentration of about 2.3% w/v. The concentration of the stabilizing agent in solution is near the saturation limit.

3. Next, 4 microliters of a solution including 10 mg/ml of E. coli derived Complex I along with 0.15% w/v of dodecyl maltoside is added to 6 microliters of the PEG solution and mixed them to generate a solution or suspension.

4. The 10 microliters of the solution is then mixed with 10 microliters of the solution including the block copolymer.

5. A small volume (e.g., 4 microliters) resulting solution is dropped onto the apertures of a subset of apertures (holes drilled through the support) of a perforated substrate of 1 mil (25.4 microns) thick KAPTON, a brand of polyimide, having apertures that are 100 micrometers in diameter and 1 mil deep.

6. The solution is allowed to air dry in a hood thereby removing the solvent.

7. Steps 5 and 6 are repeated as needed to cover all apertures.

The above-described method of introducing polypeptide to a solution containing a stabilizing polymer prior to mixing with non-aqueous solvent(s) in the presence of block copolymers is believed to stabilize the function of polypeptides used in the biocompatible membrane. However, the polymer and block copolymer could also be mixed and the resulting solution mixed with a generally aqueous polypeptide solution. Optionally one would check each aperture to ensure membrane formation, or check at least a statistically relevant number of apertures microscopically. If apertures do not contain a membrane, repair holes using additional solution and a micropipette-scaled pipetting device. It typically requires only a very small volume of solution to repair such holes. The membranes can be completely or substantially completely dried in a vacuum apparatus, or desiccator. Membranes so formed may be stored dried in vacuum or desiccated, if desired.

Where the biocompatible membrane incorporates cross-linking moieties, such as methacrylates, and will be used in a fuel cell, the following procedure can be used:

Prepare biocompatible membrane in a support that will form the cathode/anode barrier.

Assemble a cell with biocompatible membrane on anode/cathode barrier support, electrodes and buffers only.

Connect the two electrodes to a high load, such as approximately 150 kilo-Ohms.

Add hydrogen peroxide to cathode side to initiate cross-linking process, for example such that the concentration of the peroxide will be 1% by volume.

Let fuel cell stand under load for a period of time, for example 1 hour (±10%).

Adjust pH of the cathode side to below pH 5 to stop the crosslinking.

Parameters can be adjusted depending on such conditions as the membrane material, the size of biocompatible membrane, the thickness of the biocompatible membrane, the structure of the support, and the like.

Once the polypeptide/synthetic polymer material solution has been produced, it can be formed into a membrane. Biocompatible membranes in accordance with the present invention can be free standing membranes. Such membranes can be formed by pouring the solution into a pan or onto a sheet such that they achieve the desired thickness. Once the solution has been dried and the solvent dried off, the dry membrane may be removed from the pan or peeled from the backing layer. Suitable antitack agents may be used to assist in this process. Biocompatible membranes can be formed against a solid material, such as by coating onto glass, carbon that is surface modified to increase hydrophobicity, or a polymer (such as polyvinyl acetate, PDMS, Kapton®, a perfluorinated polymer, PVDF, PEEK, polyester, or UHMWPE, polypropylene or polysulfone). Polymers such as PDMS provide an excellent support that can be used to establish openings on which biocompatible membranes can be formed.

The membrane may then be cut or shaped as needed or used as is. Furthermore, to facilitate use of the membrane, it may be attached physically or through some sort of fastening device or adhesive to a holder if desired. This can be conceptualized as stretching a canvas over a frame prior to painting a picture when the frame is the support and the membrane is the canvas. Alternatively, the membrane may be formed with such a structure. A suitable analogy would be taking a child's bubble wand, used for blowing bubbles, and dipping it into a solution of soap and water. A film of soap and water forms across the opening of the wand. The structural material used at the periphery allows the film to be handled and manipulated and provides rigidity and strength. It also helps provide the desired shape of the film. The same sort of process can be employed using a physical structure and the membrane forming solutions of the present invention.

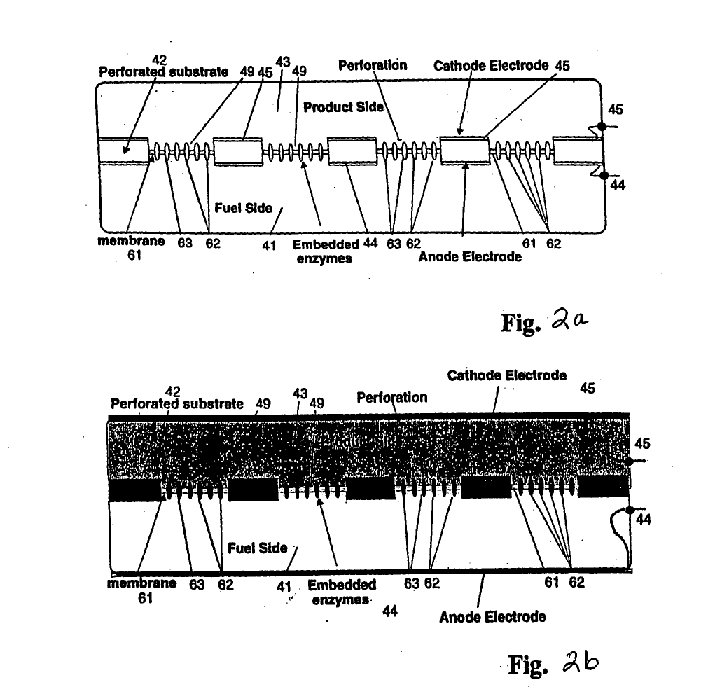

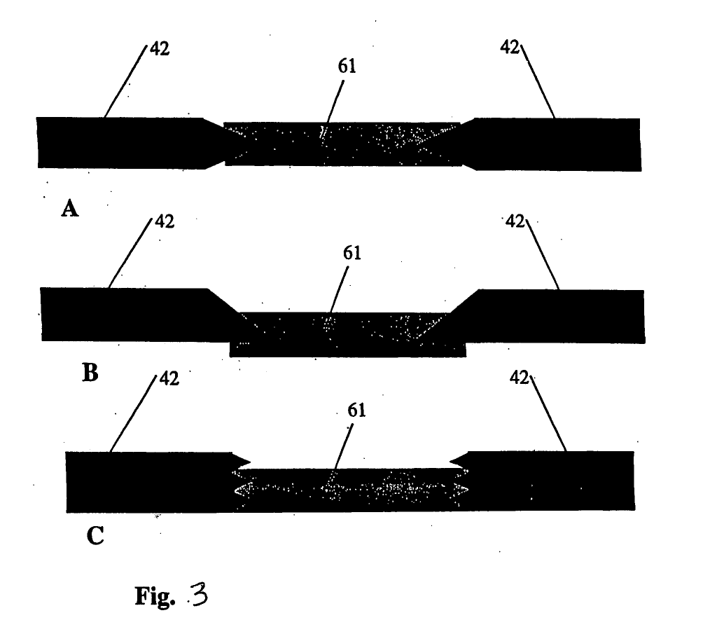

In one preferred embodiment in accordance with the present invention, a biocompatible membrane may be disposed and/or formed within or across apertures of various perforated substrates including preferably dielectric substrates. “Perforated substrates” means that it has at least one hole, aperture (synonymous with hole as used herein) or pore into which, or over which, a biocompatible membrane could be disposed. For example, FIG. 2a shows an embodiment of a membrane construction useful in a fuel cell. A perforated substrate 42, which defines various perforations 49, has its surfaces metalized to form a perforated anode 44 and a perforated cathode 45. Note also that perforated substrate 42 can be a porous substrate without, for example, drilled holes. In such instances, perforations 49 are to be understood as being pores. A biocompatible membrane 61 in accordance with the present invention is formed within the apertures or perforations 49 of perforated substrate 42. Biocompatible membrane 61 can also be disposed within the perforation and flush with anode 44 or can be attached to or adjacent cathode 45. Two membranes 61 can be provided, one, for example, disposed across the anode as illustrated and one within the perforation 49 of the substrate 42, flush with anode 45, etc. (not shown). The membranes 61 may be the same or different in terms of the synthetic polymer materials used, the polypeptides used or both. Indeed, a plurality of such membrane 61 and indeed, layers of biocompatible membrane 61 can be used in conjunction with other types of membranes, diffusive barriers and the like. While the foregoing has been explained in the context of FIG. 2a, it is equally applicable to other constructions and, in particular, any type of fuel cell construction. Biocompatible membrane 61 can include one or more polypeptides 62 and 63 as illustrated.

Note that these figures are not to scale and that the membrane may be thicker or thinner than the electrode and may be thicker or thinner than the perforated substrate 42.

Methods which can be used to form electrodes (44, 45) on a substrate include a first coating or lamination of conductor, followed by plating, sputtering or using another coating procedure to coat with titanium or a noble conductor such as gold or platinum. For anode 44, however, at least a thick plating of an ionizable metal such as zinc, aluminum or magnesium is produced. Another method for making the cathode is directly sputtering an attachment layer, such as chromium or titanium onto the support, followed by plating, sputtering or other coating procedure to attach a noble conductor. The outer metal layer can be favorably treated to increase its hydrophobicity, such as with dodecane-thiol.

Supports or substrates with high natural surface charge densities, such as Kapton and Teflon, are in some embodiments preferred. As noted above, these can be used to form the anode/cathode barrier without the use of surface electrodes. Substrate 42 is often preferably dielectric. The barrier material should also be substantially impervious to both the transmission of charge and metals or metal ions from anode to cathode side of the biocompatible membrane.

The perforations or pores 49 and metalized surfaces (anode 44 and cathode 45 (for embodiments that use so-located electrodes)) of the substrate 42 can be constructed, for example, with masking and etching techniques of photolithography well known in the art. Perforations can also be formed, for example, by punching, drilling, laser drilling, stretching, and the like. Alternatively, the metalized surfaces (electrodes) can be formed for example by (1) thin film deposition through a mask, (2) applying a blanket coat of metallization by thin film then photo-defining, selectively etching a pattern into the metallization, or (3) photo-defining the metallization pattern directly without etching using a metal impregnated resist (DuPont Fodel process, Drozdyk et al., “Photopatternable Conductor Tapes for PDP Applications,” Society for Information Display 1999 Digest, 1044-1047; Nebe et al., U.S. Pat. No. 5,049,480). In one embodiment, the perforated or porous substrate is a film. For example, the dielectric can be a porous film that is rendered non-permeable outside the “perforations” by the metallizations. The surfaces of the metal layers can be modified with other metals, for instance by electroplating. Such electroplatings are, for example, with titanium, gold, silver, platinum, palladium, mixtures thereof, or the like when used in connection with a cathode.

For an anode, ionizable metals will be used such as zinc, aluminum and manganese. All metals above hydrogen in the E-C series, excepting the alkali metals can potentially be used. In a particularly preferred embodiment, the metals used in the anode are exothermic and self-ionizing. That is, they will tend to spontaneously give up electrons in the environment of the anode compartment. Such metals include zinc, aluminum and manganese. Other metals may be used, however, in such instances, it is often necessary to drive the reaction, at least initially, in the anode compartment. This can be done, for example, by the application of energy to the anode or anode compartment or use of a very strong oxidizer in the cathode compartment that draws electrodes from the cathode, thus creating a charge imbalance, driving the oxidation of the metal anode.

In addition to metalized surfaces, the cathodes can be formed by other appropriate conductive materials, which materials can be surface modified. For example, the cathodes can be formed of carbon (graphite), including graphite fiber, which can be applied to the dielectric substrate by, for example, electron beam evaporation, chemical vapor deposition or pyrolysis. Surfaces to be metalized can be solvent cleaned and oxygen plasma etched. Useful means of forming hydrophilic electrodes are described for example in Surampudi, U.S. Pat. No. 5,773,162, Surampudi, U.S. Pat. No. 5,599,638, Narayanan, U.S. Pat. No. 5,945,231, Kindler, U.S. Pat. No. 5,992,008, Surampudi, WO 96/12317, Surampudi, WO 97/21256 and Narayanan, WO 99/16137.

Biocompatible membranes used in the invention are optionally stabilized against a solid support. One method for accomplishing such stabilization uses sulfur-mediated linkages of lipid-related molecules to glue, tether or bond metal surfaces or surfaces of another solid support to biocompatible membranes. For example, a porous support can be coated with a sacrificial or removable filler layer, and the coated surface smoothed by, for example, polishing. Such a porous support can include any of the proton-conductive polymeric membranes discussed, typically so long as the proton-conductive polymeric membrane can be smoothed following coating, and is stable to the processing described below. One useful porous support is glass frit. The smoothed surface is then coated (with prior cleaning as necessary) with metal, such as with a first layer of chrome and an overcoat of gold. The sacrificial material is then removed, such as by dissolution, taking with it the metallization over the pores but leaving a metalized surface surrounding the pores. The sacrificial layer can comprise photoresist, paraffin, cellulose resins (such as ethyl cellulose), and the like.

The tether or glue comprises alkyl thiol, alkyl disulfides, thiolipids and the like adapted to tether a biocompatible membrane as illustrated if FIGS. 7A and 7B. Such tethers are described for example in Lang et al., Langmuir 10: 197-210, 1994. Additional tethers of this type are described in Lang et al., U.S. Pat. No. 5,756,355 and Hui et al., U.S. Pat. No. 5,919,576.

FIG. 2b illustrates a preferred embodiment for fuel cells. In this figure, the arrangement of the membrane 61 and the perforated substrate 42 (a substrate containing pores, perforations or apertures) is as described previously in connection with FIG. 2a. However, the cathode 45 and anode 44 are spaced apart from the perforated substrate 42. They can be plate electrodes, but they are not plated onto the surface, or even in contact with substrate 42 or membrane 61. In this case, the membrane 61 and substrate 42 are the barrier.

In this embodiment, as in the embodiment depicted in FIG. 2a, the cathode 45 can be made of a metal or other material as desired. The anode 44 is made of a metal and preferably an exothermic or self-ionizing material such as zinc, aluminum or manganese. The anode and cathode can be plate electrodes or any other shape desired.

The biocompatible membrane can be formed across the pores, perforations or apertures 49 and polypeptides incorporated therein by, for example, the methods described in detail in Niki et al., U.S. Pat. No. 4,541,908 (annealing cytochrome C to an electrode) and Persson et al., J. Electroanalytical Chem. 292: 115, 1990. Such methods can comprise the steps of: making an appropriate solution of polypeptide and synthetic polymer material as previously discussed, the perforated substrate 49 preferably a dielectric substrate is dipped into the solution to form the enzyme-containing biocompatible membranes. Sonication or detergent dilution may be required to facilitate enzyme incorporation into a biocompatible membrane. See, for example, Singer, Biochemical Pharmacology 31: 527-534, 1982; Madden, “Current concepts in membrane protein reconstitution,” Chem. Phys. Lipids 40: 207-222, 1986; Montal et al., “Functional reassembly of membrane proteins in planar lipid bilayers,” Quart. Rev. Biophys. 14: 1-79, 1981; Helenius et al., “Asymmetric and symmetric membrane reconstitution by detergent elimination,” Eur. J. Biochem. 116: 27-31, 1981; Volumes on biomembranes (e.g., Fleischer and Packer (eds.)), in Methods in Enzymology series, Academic Press.

Alternatively, a thin partition made (preferably but not necessarily) of a hydrophobic material such as Teflon with a small aperture has a small amount of amphiphile introduced. The coated aperture is immersed in a dilute electrolyte solution upon which the droplet will thin and spontaneously self-orient spanning the aperture. Biocompatible membranes of substantial area have been prepared using this general technique. Two common methods for formation of the biocompatible membranes themselves are the Langmuir-Blodgett technique and the injection technique.

The Langmuir-Blodgett technique involves the use of a Langmuir-Blodgett trough with a partition, such as a Teflon™ polymer partition at the center. The trough is filled with aqueous solution. The aperture of the polymer partition is placed above the water level. The polypeptide and synthetic polymer material containing solution is spread over the surface and the polymer partition is lowered slowly into the aqueous solution forming a biocompatible membrane over the aperture. The injection method is similar except the polymer partition is kept fixed. In this method the aqueous phase is filled to just under the aperture, the solution is introduced over the surface and then the liquid level is raised over the partition by injecting additional electrolyte solution from underneath.

Another method for forming biocompatible membranes is using the technique of self-assembly. This is a variation from the above two described techniques and was in fact the first technique to be successfully employed to fabricate synthetic lipid membranes. The technique involves the preparation of a membrane forming solution as described above. A drop of the solution is introduced into a perforated substrate 42, often a hydrophobic substrate. The substrate 42 is then immersed in a dilute aqueous electrolyte solution whereupon the droplet will spontaneously thin and orient. The remaining material migrates to the perimeter of the layer where it forms a reservoir called the Plateau-Gibbs border.

The thickness of substrate 42, be it a perforated substrate having apertures or a porous material, is for example between about 15 micrometer (μm) to about 5 millimeters, preferably from about 15 to about 1,000 micrometers, and more preferably, from about 15 micrometer to about 30 micrometers. The width of the perforations or pores is, for example, from about 1 micrometer to about 1,500 micrometers, more preferably about 20 to about 200 micrometers, and even more preferably, about 60 to about 140 micrometers. About 100 micrometers is particularly preferred. Preferably, perforations or pores comprise in excess of about 30% of the area of any area of the dielectric substrate involved in transport between the chambers, such as from about 50 to about 75% of the area.

In certain preferred embodiments, the substrate is glass or a polymer (such as polyvinyl acetate, polydimethylsiloxane (PDMS), Kapton® (polyimide film, Dupont de Nemours, Wilmington, Del.), a perfluorinated polymer (such as Teflon, from DuPont de Nemours, Wilmington, Del.), polyvinylidene fluoride (PVDF, e.g., a semi-crystalline polymer containing approximately 59% fluorine sold as Kynar™ by Atofina, Philadelphia, Pa.), PEEK (defined below), polyester, UHMWPE (described below), polypropylene or polysulfone), soda lime glass or borosilicate glass, or any of the foregoing coated with metal. The metal can be used to anchor biocompatible membrane (such as a monolayer or bilayer of amphiphilic molecules). The metal coating can be receded from any junctions in which they provide too likely an electrically conductive pathway for a short between the anode and cathode compartments. In a particularly preferred aspect of the present invention, perforated substrate 42 is made of a dielectric material.

The polypeptide 62 can be immobilized in the biocompatible membrane with the appropriate orientation to allow access of the catalytic site for the oxidative reaction to the anode compartment and asymmetric pumping of protons. However, if the polypeptide is not asymmetrically oriented, the reverse oriented polypeptide is not detrimental for a variety of reasons depending on the context. First, the charge imbalance created by the fuel cell on the anode side drives proton transport to the cathode side even against a proton concentration gradient. In situations where the pumping is tied to the use of a reduced electron carrier, the reverse pumping has no such carrier since the electron carrier is substantially isolated in the anode compartment 41. (By “substantially isolated” those of ordinary skill will recognize sufficiently isolated to allow the fuel cell to operate.)

In one embodiment, as shown in FIGS. 4a to 4c, the biocompatible membrane 61 contains cross-linking moieties and is formed across an aperture with beveled edges to the substrate 42. The degree of beveling can be any degree that increases the stability of the biocompatible membrane. Where the cross-linked block copolymer is relatively less rigid, greater beveling can be used to increase stability, while a lesser amount of beveling can be appropriate for more rigid cross-linked block copolymer. As illustrated, numerous beveling shapes can contribute to increasing stability.

In another alternate embodiment in accordance with the present invention, the solution containing the polypeptide and the synthetic polymer material can be laid across a surface of a porous supporting material, rather than a perforated material as illustrated in FIG. 2b. Once protons, for example, were pumped across the membrane, they could migrate through the pores of the supporting barrier material.

Whether a substrate is perforated or porous, it is not necessary that a membrane be formed across its entire surface. For example, while it may be convenient to form a membrane across the entire surface of a perforated substrate, it may be preferred merely to selectively introduce a solution containing polypeptide and synthetic polymer material into the perforations or merely across the perforations.

The thickness of the biocompatible membrane in accordance with the present invention can be adjusted by known techniques such as controlling the volume introduced to a particular size pore, perforation, pan or tray, etc. The thickness of the membrane will be dictated largely by its composition and function. A membrane intended to include a transmembrane proton transporting complex such as complex I must be thick enough to provide sufficient support and orientation to the enzyme complex. It should not, however, be so thick as to prevent effective transportation of the proton across the membrane. For an aperture or perforation of about 100 microns in diameter in an array of about 100 apertures and a solution including complex I in an amount of about 4 microliters in a copolymer solution containing about 7% w/v of the poly (2-methyloxazoline)-block-poly (dimethylsiloxane)-block-poly(2-methyloxazoline)-triblock copolymer described in one of the previously identified Meier et al. articles, a membrane of suitable thickness can be obtained. The thickness of the membrane can vary widely depending upon its needed longevity, its function, etc. Membranes that are designed to transport protons for example are often thinner than membranes to which are attached an enzyme which can oxidize something. However, in general, the membranes will range from between about 10 nanometers to 100 micrometers or even thicker. Indeed, biocompatible membranes useful for transporting protons in a fuel cell have been successful at thicknesses of 10 nanometers up to 10 micrometers. Again, thicker membranes are possible.

In certain embodiments of the present invention, particularly useful in the creation of fuel cells, the biocompatible membranes of the present invention are capable of transporting protons against a pH gradient. This concept will be discussed further herein. However, conceptually, on the cathode side of the biocompatible membrane, the pH of any medium, electrolyte or the like can be acidic while on the anode side of the membrane, the pH can be basic. This is opposite of what is found in most fuel cells. Generally, such conditions would favor the transfer of protons from the proton rich acidic side to the relatively proton poor basic side. The use of membranes in accordance with the present invention can, however, pump upstream from the proton poor side to the proton rich side. This highlights another aspect of the present invention which can be particularly useful. The membranes of the present invention can also be active and functional despite relatively large variations in pH conditions on opposite sides thereof. For example, membranes in accordance with the present invention can catalyze proton transfer where the pH in an anode compartment is at least 0.5 pH units higher than the pH in the cathode compartment.

In many fuel cells, the pH in the anode compartment is lower than the pH found in the cathode compartment due to the greater concentration of protons. However, fuel cells produced in accordance with the present invention do not need to rely on proton concentration differences to drive protons across the membrane by diffusion. This can be a particularly important advantage because the species used as electron carriers and/or electron transfer mediators often work more efficiently in relatively alkaline pH. Fuel oxidation reactions may also be more efficient under such pH conditions. The pH differential, based on the electrolytes used, etc. may not need to be adjusted during the useful life of a fuel cell. Alternatively, a buffering system can be added, and additional buffer added as needed, to the anode and/or cathode compartment during operation. In one embodiment, the anode compartment will have a pH that is at least about 1 pH unit higher than the pH in the cathode compartment, more preferably 2 pH units higher. In another embodiment, the pH of the anode compartment is 8 or higher and the pH in a cathode compartment is 5 or lower. See Example No. 59. Indeed, with metallic anodes, the anolyte preferably has a pH of at least about 10, preferably 12, and most preferably about 14 or above, while the cathode compartment can be acidic.

Another aspect of the present invention is a fuel cell produced using a biocompatible membrane as described herein. Without limitation to other appropriate definitions known in the art, a fuel cell is a device that generates electrical energy by the chemical conversion of a fuel. The specific type of fuel cell, in terms of the type of fuel used, the type of electron transporting species (electron carriers, soluble enzymes, transfer mediators and the like) or electrolytes used, the types of electrodes used and the like are subject to wide variation and all are contemplated so long as they are capable of meeting the appropriate criteria. For example, the systems used must be compatible with the biocompatible membrane. If they are, for example, corrosive to the membrane, then the life of the fuel cell may be unusually short (less than 8 hours useful life). If the materials used cause sufficient instability, then that too may be reason why particular fuel, for example, may not be useful in accordance with the invention. Particularly preferred are fuel cells which are small and light enough to be used in portable electronic devices such as computers, PDAs, cell phones, beepers, personal entertainment systems, PlayStation 2, Game Boy, portable DVD players, power tools, toys, stereo equipment, radios, cameras and video recorders, digital recorders and cameras, flashlights, cars, trucks, boats, planes, etc. The fuel cells are preferably “green,” which is to say that they can be disposed of readily because they do not contain corrosive or dangerous chemicals, either as fuels or waste. In addition, these fuel cells may be refillable (adding additional fuel, etc.) or may be single use/disposable.

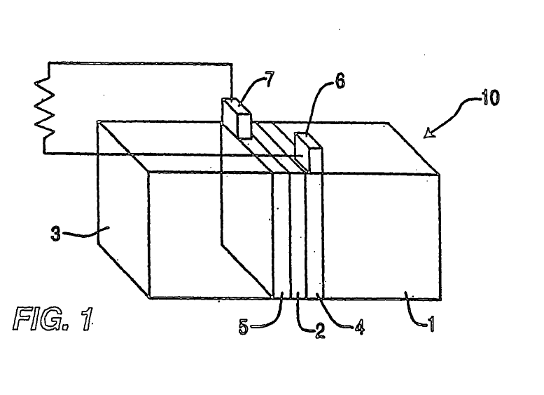

As illustrated in FIG. 1, a fuel cell in accordance with the present invention can include an anode compartment 1 having an anode 4 and a cathode compartment 3 having a cathode 5. The assembly also includes a dielectric perforated or porous substrate 2. The fuel cell also includes at least one biocompatible membrane 61 as previously described (not shown in FIG. 1). The anode 4 has an electrical lead or contact 6 and the cathode 5 has an electrical lead or contact 7 which can be electrically linked, or linked in an electrical circuit through a load or resistance so as to place them in electrical contact. The biocompatible membrane 61 can be disposed within the anode compartment within the cathode compartment or between the anode and cathode compartments. The biocompatible membrane is generally disposed between the anode and cathode and can be thought of as defining the boundary between the anode compartment and the cathode compartment. The fuel cell normally includes electrical contacts which allow a circuit to be formed between the two electrodes. The anode and cathode are preferably made of metals or other materials such as carbon in the case of the cathode, as previously described. The size and shape of the anode and cathode can be made to fit the necessary dimensions of a fuel cell and allow for passage of various chemical species. With the metals, it is the surface area exposed to the solvent that determines the maximum amount of metal which can ionize from the anode at a given pH. The higher the pH, the greater the rate of ionization per area. The more metal, overall, in general, the longer the cell will run, as long as the limit to the energy stored in the cell is the anode fuel. However, it is the process of ionization, and not the total amount of metal ions in solution, that creates the charge imbalance, i.e., a zinc atom ionizes from the anode metal and complexes with a hydroxide ion in the anolyte. As long as the pH in the anolyte is high enough to support complexation of the zinc or aluminum ions, for example, that solubilize from the surface of the anode, there does not appear to be a significant effect of the metal ion concentration in the anolyte.

Note that, if one opens the external circuit, preventing ionization of the anode metals due to a lack of electron abstraction, no solubilization of metal ions occurs. The imbalanced charge in the anode is rapidly dissipated by the membrane, that, then also ceases to transfer protons.

If an electrode is used as part of the support system for a biocompatible membrane, as illustrated in FIG. 2a, then the electrode must have sufficient perforations or other means of providing access to allow molecules, atoms, protons or electrons to flow therethrough. When the fuel cell has a configuration similar to FIG. 2b, however, it is possible that the electrodes be completely solid. However, it still may be desirable to have fuel or other components of a fuel cell able to pass through and around the electrode and therefore, it is possible to provide perforations in any event.

The biocompatible membrane useful in the fuel cell according to the present invention has already been discussed. The biocompatible membrane preferably will facilitate the passage of current in an amount that is greater than that which would result from the use of the same membrane without the polypeptide. More preferably, the biocompatible membrane will facilitate the flow of at least about 10 milliamps/cm², more preferably at least about 50 milliamps/cm², and most preferably at least about 100 milliamps/cm². In the simplest embodiment, the biocompatible membrane is itself free standing and able to support itself or to be supported by a peripheral structure and is disposed between an anode and cathode. It is also important in this instance that the biocompatible membrane itself be dielectric and that it prevent the free flow of certain components between the anode and cathode compartments such as catholyte, electrolyte, cathode fuel, analyte anode fuel, other ions, and, most especially, metals or metal ions from the anode.

The next least complicated embodiment would involve the use of a similar biocompatible membrane, but one that is either incapable of preventing the complete intermixing of the necessary species or which is not dielectric. In such an instance, an additional barrier may be necessary. Such barriers can be made of the same materials used to produce the substrate 42 described earlier or, in the alternative, as illustrated in FIGS. 2a and 2b, the membrane can be disposed either in or covering perforations or pores in a substrate 42. Materials useful for the substrate and the methods of preparing same have already been discussed.

The anode electrode or anode 44 is, as previously noted, produced from one or more metals. Preferably, these metals are exothermic or, under the conditions of the anode compartment (generally basic conditions), selfionizing. By this it is meant that the metal will somewhat spontaneously lose electrons so as to become positively charged.
M>Mⁿ⁺_{(aqueous)}+ne⁻.

In this case, M is a metal atom, n is the number of electrons lost and positive charge gained by the metal ion. Zinc, for example, is capable of losing two electrons. Therefore, M would be zinc (Zn)>Zn²⁺_{(aqeous)}+2e⁻. The metal ion reacts with hydroxy groups found in an aqueous medium, particularly one kept under basic conditions to create a metal hydroxide. Often the metal hydroxide will precipitate out. It is also possible that metal oxide and various other forms are created during this process. However, the most important thing in the context of the present invention is the creation of positively charged metal ions.

Metal species are able to transfer their charge to the proton pumping polypeptides that form part of the membrane or barrier. While such proton pumping may be facilitated by a relatively higher amount of positive charge on the anode side, the cathode can be kept under acidic conditions. Therefore, the transportation of protons across the membrane can also occur against a concentration gradient. In essence, such cells are pumping uphill.

The amount of excess charge maintained in the anode is inversely proportional to the energy barrier the membrane protein presents. Since the protein does not transfer protons in the absence of an electric field (created by the charge imbalance) such a barrier must exist as a non-zero quantity. However, as the process of ionization involves the transfer of an electron from the anode, through the circuit, to the cathode, there is a charge imbalance created, one in which the anode becomes positively charged, relative to the cathode. In such a case, the field generated causes a proton to transit the structure of the protein-containing membrane. As the proton is presumably the only ion which the protein can bind and transfer, it is transferred in response to the charge differential, in preference to the metal ions. So, although the metal ion is complexed with hydroxyl groups, the ion that was complexed with such a group (primarily a proton in water) is now freed, and unbalanced. The ability of the anode compartment to retain excess charge is also dependent upon the ionic strength of the anolyte, the materials used in the composition of the anode compartment (polarizability) etc. Expressed as the capacitance of the anode compartment, then at 100 microFarads, and 2 Volts, then the net charge could be as much as 200 microCoulombs. However, this would be dissipated in 200 milliseconds by a 1 milliAmp current.

The metals, metal ions, and the compounds resulting from the reaction of metals and other constituents within the anode compartment are substantially contained within the anode compartment. Only the charge is transferred to the cathode compartment through the membrane and the electrons are transferred through electrical circuitry between the anode and cathode.

Some of the fuel cells produced in accordance with the present invention have the advantage of being able to be stopped. For example, zinc metal will eventually achieve an equilibrium in the anode compartment once current flow is terminated. That equilibrium will prevent the complete consumption of the metal anode, allowing the flow of current to be started and stopped at discreet time intervals and yet relatively little useful life of the fuel cell is lost. Other metals cannot achieve same. However, aluminum, for example, can generate considerably more energy than zinc.

While it is preferred to use generally exothermic metals that can generally spontaneously provide for the generation of positive charge, it is possible to use other metals as well. However, in such instances, it may be necessary to initiate the reaction process using some form of driving force. The driving force may be, for example, the introduction of energy into the anode or anode compartment to generate ions. Indeed, any manner of generating metal ions in the anode compartment may be used. Preferably, such techniques will not require sustained application but instead might be used only to initiate the generation in metal ions. Additionally, it is preferred that the means for inducing the generation of metal ions require less energy input than the energy output realized from the fuel cell.

Another possible mechanism for creating metal ions is introduction of a charge imbalance. The use of strong oxidizing agents such as CaO₂, NaO₂ or MgO₂ in the cathode compartment can effectively draw electrons from the cathode. This creates a charge imbalance that can induce the creation of metal ions and positive charge in the anode compartment. Any other technique useful for generating charge in the anode compartment so as to initiate or facilitate the generation of metal ions are contemplated. Indeed, in one preferred embodiment, multiple techniques are used. For example, zinc or aluminum anodes can be used that are exothermic and will readily produce metal ions. At the same time, a strong oxidizer such as CaO₂ can be used in the cathode compartment. In such a cell, the pH of the cathode compartment is preferably 5 or below, more preferably between 1 and 2. The anode pH preferably is 10 or above, more preferably 12 or above, and even more preferably 14 or above. In this configuration, up to 1% hydrogen peroxide would be used in the cathode compartment. The amount of oxidizer could range from about 0.1% to 1.5% and a strongly alkaline buffer, preferably non-electrolyzable (TMA-OH is preferred, though it is possible to use sodium or potassium hydroxide, as well) could be present.

Some embodiments of the invention can, in addition, use a traditional form of anode/cathode barrier: a polymeric membrane selected for it ability to passively conduct protons in conjunction with the biocompatible membrane of the invention. The former anode/cathode barrier is useful since it is effective to pump against a proton gradient.

Dual membranes can be disposed across and/or within the perforations or pores of an anode/cathode barrier or can be placed between the anode and cathode compartments. These membranes can be of the traditional composition or biocompatible membranes. One context in which such dual membranes are observed is that in which the pores are of relatively narrow diameter. Another context is one in which the anode cathode barrier is formed of sandwiched materials such that separate junctions between differing materials nucleate the formation of separate biocompatible membranes across the pore.

Without limitation to theory, it is believed that the second, more cathode proximate biocompatible membrane, operates to some degree passively, as the pumping from the first biocompatible membrane creates a high proton concentration, driving passive transport to the cathode compartment. Thus, to the extent the cathode compartment contains peroxide that could prospectively damage the transport protein, the active transport function can be damaged, while the second biocompatible membrane insulates the first from higher concentrations of the peroxide.

In one embodiment, the dual membrane benefit is obtained with one or more biocompatible membranes, the first of which (at the anode side) incorporates the polypeptide and a proton-conductive polymeric membrane fitted at the cathode chamber side to limit peroxide transit towards the biocompatible membranes. Again, an intermediate zone between the biocompatible membrane(s) and the proton-conductive polymeric membrane gains a high proton concentration due to active transport, driving further transit along a concentration gradient into the cathode compartment.

In one embodiment, the substrate in which the pores are formed is a sandwich of dielectric Kapton, and conductive Kapton (conductive through the presence of incorporated graphite). The conductive Kapton can form the anode electrode, or be appropriately metalized to form the anode electrode. The three layers are relatively hydrophilic, relatively hydrophobic, then relatively hydrophilic.

The reaction at the cathode in the cathode compartment can be any reaction that consumes the produced electrons with a useful redox potential. Using oxygen, for example, the reaction can be:

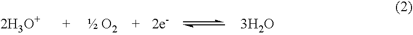

Using reaction 2, the catholyte solution (an electrolyte used in the cathode compartment) can be buffered to account for the consumption of hydrogen ions, hydrogen ion donating compounds can be supplied during operation of the fuel cell, or more preferably, the barrier between the anode and cathode compartments is sufficiently effective to deliver the neutralizing hydrogen ions (hydrogen ion or proton).

In one embodiment, the corresponding reaction at the cathode is:
H₂O₂+2H⁺+2e⁻ [symbol] 2H₂O (10)

The cathode reactions result in a net production of water, which, if significant, can be dealt with by, for example, providing for space for overflow liquid, or providing for vapor-phase exhaust. A number of electron acceptor molecules are often solids at operating temperatures or solutes in a carrier liquid, in which case the cathode chamber should be adapted to carry such non-gaseous material.

Where, as possibly the case with hydrogen peroxide as the electron acceptor molecule, the electron acceptor molecule can damage the polypeptides of the biocompatible membrane and any other species in the anode chamber, and a scavenger for such electron acceptor molecules can be used in the fuel cell to prevent peroxide or damaging electron acceptor molecules from entering the anode chamber. Such a scavenger can be, for example, the enzyme catalase (2H₂O₂™ 2H₂O+O₂), especially where conditions at the anode electrode are not effective to catalyze electron transfer to O₂. Alternatively, the scavenger can be any noble metal, such as gold or platinum. Such a scavenger, where an enzyme, can be covalently linked to a solid support material. Alternatively, a barrier between the anode chamber and the cathode chamber is provided and has at most limited permeability to hydrogen peroxide.

Solid oxidants, such as calcium peroxide, potassium perchlorite (KClO₄) or potassium permanganate (KMnO₄), can be used as the electron acceptor.

The fuel cell operates within a temperature range polypeptide or proton transporter. This temperature range typically varies with the stability of the enzyme, and the source of the enzyme. To increase the appropriate temperature range, one can select the appropriate redox enzyme from a thermophilic organism, such as a microorganism isolated from a volcanic vent or hot spring. Additionally genetically modified enzymes can be used. Nonetheless, preferred temperatures of operation of at least the first electrode are about 80° C. or less, preferably 60° C. or less.

As shown in FIG. 1, preferred fuel cells 10 in accordance with the present invention include an anode compartment 1, a cathode compartment 3, an anode 4 and a cathode 5, as well as a biocompatible membrane 2 (and possibly a barrier) described herein including a polypeptide capable of participating in the transfer of protons from one side of the membrane to the other. Electrical leads 6 and 7 are also provided to facilitate completion of a circuit. The biocompatible membrane, with or without other support structure or dielectric materials forms a barrier that prevents the passage of various components between and among the anode and cathode compartments. Indeed, this barrier structure generally defines the interface between the anode and cathode compartments and is disposed therebetween. The biocompatible membrane and any support structure, e.g., the barrier, will permit protons or other positive charge to be transferred and preferably pumped from the anode compartment to the cathode compartment. They will prevent, however, the passage of metals and in particular metal ions from the anode compartment to the cathode compartment.

Preferably, both anode and cathode compartments contain an electrolyte (an anolyte in the case of the anode compartment and a catholyte in the case of the cathode compartment). The anode compartment also contains fuel that, in this context, is the metal anode itself. “The fuel cells of the present invention can preferably generate at least about 10 milliwatts/cm², more preferably at least about 50 milliwatts/cm² and most preferably at least about 100 milliwatts/cm² over its useful life (there will be some diminished output toward the end of its life). The fuel cell will preferably generate such power density until its fuel ultimately runs out (unless they are refillable), but generally at least eight hours, preferably one week, more preferably a month and most preferably six months or more.

### EXAMPLES

### Example No. 1

A solution useful for producing a biocompatible membrane in accordance with the present invention was produced as follows: 7% w/v (70 mg) of a block copolymer (poly (2-methyloxazoline)-polydimethyl siloxane-poly(2-methyl(oxazoline) having an average molecular weight of 2 KD-5 KD-2 KD was dissolved in an 95% v/v/5% v/v ethanol/water solvent mixture with stirring using a magnetic stirrer. Six microliters of this solution was removed and mixed with four microliters of a solution containing 0.015% w/v dodecyl maltoside, 40 micrograms of Complex I (10 mg/ml) in water. This is then mixed. The resulting solution contains 4.2% w/v polymer, 55% EtOH v/v, 45% H₂O v/v, 0.06% w/v dodecyl maltoside and protein/polymer ratio is 6% w/w.

### Example No. 2

A solution useful for producing a biocompatible membrane in accordance with the present invention was prepared generally as described in Example No. 1 with the following changes: less polypeptide solution was used so as to provide a final solution including 0.015% w/v dodecyl maltoside and 1.5% w/w polypeptide relative to synthetic polymer materials.

### Example No. 3

A solution useful for producing a biocompatible membrane in accordance with the present invention was prepared generally as described in Example No. 1 with the following changes: less polypeptide solution was used so as to provide a final solution including 0.03% w/v dodecyl maltoside and the final solution contained 3.0% w/w polypeptide relative to synthetic polymer materials.

### Example No. 4

A solution useful for producing a biocompatible membrane in accordance with the present invention was prepared generally as described in Example No. 1 with the following changes: less polypeptide solution was used so as to provide a final solution including 0.045 w/v dodecyl maltoside and the final solution contained 4.5% w/w polypeptide relative to synthetic polymer materials.

### Example No. 5

A solution useful for producing a biocompatible membrane in accordance with the present invention was prepared generally as described in Example No. 1 with the following changes: less polypeptide solution was used so as to provide a final solution including 0.0075 w/v dodecyl maltoside and the final solution contained 0.75% w/w polypeptide relative to synthetic polymer materials.

### Example No. 6

A solution useful for producing a biocompatible membrane in accordance with the present invention was prepared generally as described in Example No. 5 with the following changes: the synthetic polymer material was originally present in a solution of 5.0% w/v. Sufficient polypeptide solution of the type described in Example 1 was added so as to produce a final solution including 0.0075% w/v dodecyl maltoside and 0.75% w/w polypeptide relative to synthetic polymer materials.

### Example No. 7

A solution useful for producing a biocompatible membrane in accordance with the present invention was prepared generally of the type described in Example No. 6 with the following changes: sufficient polypeptide solution as described in Example 1 was included so as to produce a final solution including 0.015% w/v dodecyl maltoside and the final solution contained 1.5% w/w polypeptide relative to synthetic polymer materials.

### Example No. 8

A solution useful for producing a biocompatible membrane in accordance with the present invention was prepared generally of the type described in Example No. 6 with the following changes: sufficient polypeptide solution as described in Example 1 was included so as to produce a final solution including 0.03% w/v dodecyl maltoside and the final solution contained 3% w/w polypeptide relative to synthetic polymer materials.

### Example No. 9

A solution useful for producing a biocompatible membrane in accordance with the present invention was prepared generally of the type described in Example No. 6 with the following changes: sufficient polypeptide solution as described in Example 1 was included so as to produce a final solution including 0.045% w/v dodecyl maltoside and the final solution contained 4.5% w/w polypeptide relative to synthetic polymer materials.

### Example No. 10

A solution useful for producing a biocompatible membrane in accordance with the present invention was prepared generally of the type described in Example No. 6 with the following changes: sufficient polypeptide solution as described in Example 1 was included so as to produce a final solution including 0.06% w/v dodecyl maltoside and the final solution contained 6.0% w/w polypeptide relative to synthetic polymer materials.

### Examples Nos. 11-15

Solutions useful for producing a biocompatible membrane in accordance with the present invention were prepared generally as described in Example Nos. 1-5 respectively except that the amount of the synthetic polymer material used in each solution was originally 10% w/v. When 6 microliters of that solution was mixed with sufficient polypeptide solution of the type described in Example 1 a final solution was produced including 0.06, 0.15, 0.03, 0.045 and 0.0075% w/v dodecyl maltoside and 6.0, 1.5, 3.0, 4.5 and 0.75% w/w polypeptide relative to synthetic polymer materials, respectively.

### Example No. 16

A solution useful for producing a biocompatible membrane in accordance with the present invention was prepared generally as described in Example No. 3, however, the solvent used to dissolve the synthetic polymer material included ethanol, 25% methanol v/v and the amount of water indicated in Example No. 3. Sufficient polypeptide solution was used so as to provide a final solution including 0.03% w/v dodecyl maltoside and 3.0% w/w polypeptide relative to synthetic polymer materials.

### Example No. 17

A solution useful for producing a biocompatible membrane in accordance with the present invention was prepared generally as described in Example No. 2, however, the solvent used to dissolve the synthetic polymer material included 47.5% v/v ethanol, 2.5% v/v water, 25% v/v Tetrahydrofuran (“THF”), 25% v/v dichloromethane. Sufficient polypeptide solution was used so as to provide a final solution including 0.015. % w/v dodecyl maltoside and 1.5% w/w polypeptide relative to synthetic polymer materials.

### Example No. 18

A solution useful for producing a biocompatible membrane in accordance with the present invention can be prepared generally as described in Example No. 6, however, the solvent used to dissolve the synthetic polymer material included 9.5% v/v ethanol, 0.5% v/v water, 40% v/v acetone, and 40% v/v hexane.

### Examples Nos. 19-24

Solutions useful for producing a biocompatible membrane in accordance with the present invention were prepared generally as described in Example Nos. 11-15 above, however, the final concentration of dodecyl maltoside was 0.15% w/v. Solutions useful for producing a biocompatible membrane in accordance with the present invention can be prepared generally as described in Example No. 4 above, however, the balance of the surfactant used in the polypeptide solution is dodecyl P-D-glucopyranoside and the final concentration of the surfactants is 0.15% w/v.

### Example No. 26

A solution useful for producing a biocompatible membrane in accordance with the present invention was prepared generally as described in Example No. 9 above, however, the surfactant used in the polypeptide solution included a mixture of a polymeric surfactant sold under the trademark PLURONIC L101, lot WPDX-522B from BASF, Ludwigshafen Germany and the same concentration of dodecyl maltoside specified in Example No. 9. The polymeric surfactant was diluted to 0.1% v/v of its supplied concentration in the final solution.

### Example No. 27

A solution useful for producing a biocompatible membrane in accordance with the present invention was prepared generally as described in Example No. 2 above, however the surfactant used in the polypeptide solution included a mixture of a polymeric surfactant sold under the trademark DISPERPLAST, lot no. 31J022 from BYK Chemie, Wallingford Conn. and the same concentration of dodecyl maltoside specified in Example No. 2. The polymeric surfactant was diluted to 0.135% v/v of the supplied concentration in the final solution.

### Examples Nos. 28-32

Solutions useful for producing a biocompatible membrane in accordance with the present invention can be prepared generally as described in Example Nos. 6-10 respectively, however, the synthetic polymer material used can be a poly(2-methyloxazoline)-polydimethylsiloxane-poly(2-methyloxazoline) (5% w/v) having an average molecular weight of 3 kD-7 kD-3 kD. When 6 microliters of that solution is mixed with sufficient polypeptide solution of the type described in Example 1 a final solution is produced including 0.0075, 0.015, 0.030, 0.045 and 0.060% w/v dodecyl maltoside and 0.75, 1.5, 3.0, 4.5 and 6.0% w/w polypeptide relative to synthetic polymer materials respectively.

### Examples Nos. 33-38

Solutions useful for producing a biocompatible membrane in accordance with the present invention were prepared generally as described in Example Nos. 1-5 respectively, however, the synthetic polymer material used was a mixture of two block copolymers, both of which were poly(2-methyloxazoline)-polydimethylsiloxane-poly(2-methyloxazoline), (total 7% w/v) one of which having an average molecular weight of 2 kD-5 kD-2 kD and the other 1 kD-2 kD-1 kD and the ratio of the first block copolymer to the second was about 67% to 33% of the total polymer used w/w. When 6 microliters of that solution was mixed with sufficient polypeptide solution of the type described in Example 1 a final solution was produced including 0.06, 0.015, 0.030, 0.045 and 0.0075% w/v dodecyl maltoside and 0.75, 1.5, 3.0, 4.5 and 6.0% w/w polypeptide relative to synthetic polymer materials respectively.

### Examples Nos. 39-43

Solutions useful for producing a biocompatible membrane in accordance with the present invention can be prepared generally as described in Example Nos. 11-15 respectively, however, the synthetic polymer material used can be a mixture of two block copolymers, both of which are poly(2-methyloxazoline)-polydimethylsiloxane-poly(2-methyloxazoline), (10% w/v) one of which having an average molecular weight of 1 kD-2 kD-1 kD and the other 3 kD-7 kD-3 kD and the ratio of the first block copolymer to the second being about 33% to 67% of the total polymer used w/w. When 6 microliters of that solution is mixed with sufficient polypeptide solution of the type described in Example 1 a final solution is produced including 0.075, 0.15, 0.30, 0.45 and 0.60% w/v dodecyl maltoside and 0.75, 1.5, 3.0, 4.5 and 6.0% w/w polypeptide relative to synthetic polymer materials respectively.

### Examples Nos. 44-48

Solutions useful for producing a biocompatible membrane in accordance with the present invention can be prepared generally as described in Examples Nos. 6-10 respectively, however, the synthetic polymer material used can be a mixture of two block copolymers, both of which are poly(2-methyloxazoline)-polydimethylsiloxane-poly(2-methyloxazoline), (5% w/v) one of which having an average molecular weight of 2 kD-5 kD-2 kD and the other 3 kD-7 kD-3 kD and the ratio of the first block copolymer to the second being about 33% to 67% of the total polymer used w/w. When 6 microliters of that solution is mixed with sufficient polypeptide solution of the type described in Example 1 a final solution is produced including 0.0075, 0.015, 0.030, 0.045 and 0.060% w/v dodecyl maltoside and 0.75, 1.5, 3.0, 4.5 and 6.0% w/w polypeptide relative to synthetic polymer materials respectively.

### Examples Nos. 49-53

Solutions useful for producing a biocompatible membrane in accordance with the present invention can be prepared generally as described in Example Nos. 1-5 respectively, however, the synthetic polymer material used can be a mixture of two block copolymers, both of which are poly(2-methyloxazoline)-polydimethylsiloxane-poly(2-methyloxazoline), (7% w/v) one of which having an average molecular weight of 2 kD-5 kD-2 kD and the other 3 kD-7 kD-3 kD and the ratio of the first block copolymer to the second being about 67% to 33% of the total polymer used w/w. When 6 microliters of that solution is mixed with sufficient polypeptide solution of the type described in Example 1 a final solution is produced including 0.06, 0.015, 0.030, 0.045 and 0.0075% w/v dodecyl maltoside and 6.0, 1.5, 3.0, 4.5 and 0.025% w/w polypeptide relative to synthetic polymer materials respectively.

### Examples Nos. 54-58

Solutions useful for producing a biocompatible membrane in accordance with the present invention can be prepared generally as described in Examples Nos. 1-5 respectively, however, the synthetic polymer used can be a mixture of poly(2-methyloxazoline)-polydimethylsiloxane-poly(2-methyloxazoline) (7% w/v) having an average molecular weight of 2 kD-5 kD-2 kD in a solvent of 95% ethanol, 5% water mixed with a solution of 23.5% w/v polyethylene glycol with an average molecular weight of approximately 3,300 Daltons in water in the proportion of 85% triblock copolymer solution, 15% polyethylene glycol solution v/v. When 6 microliters of that solution is mixed with sufficient polypeptide solution of the type described in Example 1 a final solution is produced including 0.06, 0.015, 0.030, 0.045 and 0.0075% w/v dodecyl maltoside and 6.0, 1.5, 3.0, 4.5 and 0.75% w/w polypeptide relative to synthetic polymer materials respectively.

### Examples Nos. 59-63

A solution useful for producing a biocompatible membrane in accordance with the present invention was prepared generally as described in Example No. 12, however, the synthetic polymer used was a mixture of 10% w/v of poly(2-methyloxazoline)-polydimethylsiloxane-poly(2-methyloxazoline) having an average molecular weight of 2 kD-5 kD-2 kD in a solvent of 95% ethanol, 5% water mixed with a solution of 23.5% w/v polyethylene glycol with an average molecular weight of approximately 8,000 Daltons in water in the proportion of 85% triblock copolymer solution, 15% polyethylene glycol solution v/v. When 6 microliters of that solution was mixed with sufficient polypeptide solution of the type described in Example 1 a final solution was produced including 0.15% w/v dodecyl maltoside and 1.5% w/w polypeptide relative to synthetic polymer materials. Similar solutions can be made using the procedures of examples 11 and 13-15.

### Examples Nos. 64-68

Solutions useful for producing a biocompatible membrane in accordance with the present invention can be prepared generally as described in Examples Nos. 28-32 respectively, however, the synthetic polymer used can be a mixture of 5% w/v of poly(2-methyloxazoline)-polydimethylsiloxane-poly(2-methyloxazoline) having an average molecular weight of 3 kD-7 kD-3 kD in a solvent of 95% ethanol, 5% water mixed with a solution of 23.5% w/v polyethylene glycol with an average molecular weight of approximately 3,300 Daltons in water in the proportion of 85% triblock copolymer solution, 15% polyethylene glycol solution v/v. When 6 microliters of that solution is mixed with sufficient polypeptide solution of the type described in Example 1 a final solution is produced including 0.0075, 0.015, 0.030, 0.045 and 0.060% w/v dodecyl maltoside and 0.75, 1.5, 3.0, 4.5 and 6.0% w/w polypeptide relative to synthetic polymer materials respectively.

### Examples Nos. 69-73

Solutions useful for producing a biocompatible membrane in accordance with the present invention can be prepared generally as described in Examples Nos. 1-5 respectively, however, the synthetic polymer used can be a mixture of 7% w/v of poly(2-methyloxazoline)-polydimethylsiloxane-poly (2-methyloxazoline) having an average molecular weight of 3 kD-7 kD-3 kD in a solvent of 95% ethanol, 5% water mixed with a solution of 23.5% w/v polyethylene glycol with an average molecular weight of approximately 8,000 Daltons in water in the proportion of 85% triblock copolymer solution, 15% polyethylene glycol solution v/v. When 6 microliters of that solution is mixed with sufficient polypeptide solution of the type described in Example 1 a final solution is produced including 0.060, 0.015, 0.030, 0.045 and 0.0075% w/v dodecyl maltoside and 6.0, 1.5, 3.0, 4.5 and 0.75% w/w polypeptide relative to synthetic polymer materials respectively.

### Examples Nos. 74-78

Solutions useful for producing a biocompatible membrane in accordance with the present invention can be prepared generally as described in Examples Nos. 6-10 respectively, however the synthetic polymer used can be a mixture of 5% w/v of poly(2-methyloxazoline)—polydimethylsiloxane-poly(2-methyloxazoline) having an average molecular weight of 2 kD-5 kD-2 kD in a solvent of 50% v/v acetone, 50% v/v heptane mixed with a solution of 5% w/v polystyrene of about 250,000 in molecular weight in 50% v/v acetone, 50% v/v octane in the proportion of 80% v/v block copolymer, 20% v/v polystyrene. When 6 microliters of that solution is mixed with sufficient polypeptide solution of the type described in Example 1 a final solution is produced including 0.0075, 0.015, 0.030, 0.045 and 0.060% w/v dodecyl maltoside and 0.75, 1.5, 3.0, 4.5 and 6.0% w/w polypeptide relative to synthetic polymer materials respectively.

### Examples Nos. 79-83

Solutions useful for producing a biocompatible membrane in accordance with the present invention can be prepared generally as described in Examples Nos. 1-5 respectively, however, the synthetic polymer used can be a mixture of 7% w/v of poly(2-methyloxazoline)-polydimethylsiloxane-poly(2-methyloxazoline) having an average molecular weight of 2 kD-5 kD-2 kD in a solvent of 95% ethanol, 5% water mixed with a solution of 5% w/v of polymethylmethacrylate-polydimethylsiloxane-polymethylmethacrylate having an average molecular weight of 4 kD-8 kD-4 kD in a solvent of 50% v/v THF, 50% v/v dichloromethane in the proportion of 66% v/v to 33% v/v, respectively. When 6 microliters of that solution is mixed with sufficient polypeptide solution of the type described in Example 1 a final solution is produced including 0.06, 0.015, 0.030, 0.045 and 0.0075% w/v dodecyl maltoside and 6.0, 1.5, 3.0, 4.5 and 0.075% w/w polypeptide relative to synthetic polymer materials respectively.

### Examples Nos. 84-88

Solutions useful for producing a biocompatible membrane in accordance with the present invention were prepared generally as described in Examples Nos. 11-15 respectively, however, the synthetic polymer material used was 10% w/v of sulfonated styrene/ethylene-butylene/sulfonated styrene, supplied as Protolyte® A700, lot number LC-29/60-011 by Dais Analytic, Odessa, Fla. in solvent as supplied, diluted 50% v/v with ethanol containing 5% v/v water. When 6 microliters of that solution was mixed with sufficient polypeptide solution of the type described in Example 1 a final solution was produced including 0.0075, 0.015, 0.030, 0.045 and 0.060% w/v dodecyl maltoside and 0.75, 1.5, 3.0, 4.5 and 6.0% w/w polypeptide relative to synthetic polymer materials respectively.

### Example No. 89

A solution useful for producing a biocompatible membrane in accordance with the present invention can be prepared generally as described in Example No. 84 however, the solvent used to dilute the synthetic polymer material can include 50% v/v Tetrahydrofuran (“THF”), 50% v/v dichloromethane.

### Examples Nos. 90-94

Solutions useful for producing a biocompatible membrane in accordance with the present invention were prepared generally as described in Examples Nos. 84-88 above, however, the final concentration of dodecyl maltoside was 0.15% w/v.

### Example No. 95

Solutions useful for producing a biocompatible membrane in accordance with the present invention can be prepared generally as described in Example No. 85 above, however, the surfactant used in the polypeptide solution can include a mixture of dodecyl P-D-glucopyranoside and dodecyl maltoside and the final concentration of the surfactants is 0.15% w/v.

### Example No. 96

A solution useful for producing a biocompatible membrane in accordance with the present invention was prepared generally as described in Example No. 87 above, however, the surfactant used in the polypeptide solution included a mixture of a polymeric surfactant sold under the trademark PLURONIC L101, lot WPDX-522B from BASF, Ludwigshafen Germany and the same concentration of dodecyl maltoside specified in Example No. 87. The polymeric surfactant was diluted to 0.1% v/v of its supplied concentration in the final solution.

### Example No. 97

A solution useful for producing a biocompatible membrane in accordance with the present invention was prepared generally as described in Example No. 88 above, however, the surfactant used in the polypeptide solution included a mixture of a polymeric surfactant sold under the trademark DISPERPLAST, lot no. 31J022 from BYK Chemie, Wallingford Conn. and the same concentration of dodecyl maltoside specified in Example No. 88. The final concentration of the polymeric surfactant was diluted to 0.135% v/v of the supplied concentration in the final solution.

### Examples No. 98-102

Solutions useful for producing a biocompatible membrane in accordance with the present invention were prepared generally as described in Examples Nos. 84-88 respectively, however, the synthetic polymer material used was a mixture of two block copolymers, one of which was 10% w/v of sulfonated styrene/ethylene-butylene/sulfonated styrene, supplied as Protolyte® A700, lot number LC-29/60-011 by Dais Analytic, Odessa, Fla. in solvent as supplied, diluted 50% v/v with ethanol containing 5% v/v water, the other of which was 5% w/v of poly(2-methyloxazoline)-polydimethylsiloxane-poly (2-methyloxazoline) having an average molecular weight of 2 kD-5 kD-2 kD and the ratio of the first block copolymer to the second was about 67% to 33% of the total polymer used w/w. When 6 microliters of that solution was mixed with sufficient polypeptide solution as described in Example 1 a final solution was produced including 0.0075, 0.015, 0.030, 0.045 and 0.060% w/v dodecyl maltoside and 0.75, 1.5, 3.0, 4.5 and 6.0% w/w polypeptide relative to synthetic polymer materials respectively.

### Examples Nos. 103-107

Solutions useful for producing a biocompatible membrane in accordance with the present invention were prepared generally as described in Examples Nos. 84-88 respectively, however, the synthetic polymer material used was a mixture of two block copolymers, one of which was 10% w/v of sulfonated styrene/ethylene-butylene/sulfonated styrene, supplied as Protolyte® A700, lot number LC-29/60-011 by Dais Analytic, Odessa, Fla. in solvent as supplied, diluted 50% v/v with ethanol containing 5% v/v water, the other of which was 5% w/v of poly(2-methyloxazoline)-polydimethylsiloxane-poly (2-methyloxazoline) having an average molecular weight of 2 kD-5 kD-2 kD and the ratio of the first block copolymer to the second was about 33% to 67% of the total polymer used w/w. When 6 microliters of that solution was mixed with sufficient polypeptide solution as described in Example 1 a final solution was produced including 0.0075, 0.015, 0.030, 0.045 and 0.060% w/v dodecyl maltoside and 0.75, 1.5, 3.0, 4.5 and 6.0% w/w polypeptide relative to synthetic polymer materials respectively.

### Examples Nos. 108-112

Solutions useful for producing a biocompatible membrane in accordance with the present invention can be prepared generally as described in Examples Nos. 103-107 respectively, however, the synthetic polymer material used can be a mixture of two block copolymers, one of which is 10% w/v of sulfonated styrene/ethylene-butylene/sulfonated styrene, supplied as Protolyte® A700, lot number LC-29/60-011 by Dais Analytic, Odessa, Fla. in solvent as supplied, diluted 50% v/v with ethanol containing 5% v/v water, the other of which is 5% w/v of polymethylmethacrylate-polydimethylsiloxane-polymethylmethacrylate having an average molecular weight of 4 kD-8 kD-4 kD in a solvent mixture of 50% v/v THF, 50% v/v dichloromethane, the ratio of the first block copolymer to the second being about 67% to 33% of the total polymer used w/w. When 6 microliters of that solution is mixed with sufficient polypeptide solution of the type described in Example 1 a final solution is produced including 0.0075, 0.015, 0.030, 0.045 and 0.060% w/v dodecyl maltoside and 0.75, 1.5, 3.0, 4.5 and 6.0% w/w polypeptide relative to synthetic polymer materials respectively.

### Examples Nos. 113-117

Solutions useful for producing a biocompatible membrane in accordance with the present invention can be prepared generally as described in Examples Nos. 103-107 respectively, however, the synthetic polymer material used can be a mixture of two block copolymers, one of which is 10% w/v of sulfonated styrene/ethylene-butylene/sulfonated styrene, supplied as Protolyte® A700, lot number LC-29/60-011 by Dais Analytic, Odessa, Fla. in solvent as supplied, diluted 50% v/v with ethanol containing 5% v/v water, the other of which is 5% w/v of polymethylmethacrylate-polydimethylsiloxane-polymethylmethacrylate having an average molecular weight of 4 kD-8 kD-4 kD in a solvent mixture of 50% v/v THF, 50% v/v dichloromethane, the ratio of the first block copolymer to the second being about 33% to 67% of the total polymer used w/w. When 6 microliters of that solution is mixed with sufficient polypeptide solution of the type described in Example 1 a final solution is produced including 0.0075, 0.015, 0.030, 0.045 and 0.060% w/v dodecyl maltoside and 0.75, 1.5, 3.0, 4.5 and 6.0% w/w polypeptide relative to synthetic polymer materials respectively.

### Examples Nos. 118-122

Solutions useful for producing a biocompatible membrane in accordance with the present invention were prepared generally as described in Examples Nos. 84-88 respectively, however, the synthetic polymer material used was a mixture of 10% w/v of sulfonated styrene/ethylene-butylene/sulfonated styrene, supplied as Protolyte® A700, lot number LC-29/60-011 by Dais Analytic, Odessa, Fla. in solvent as supplied, diluted 50% v/v with ethanol containing 5% v/v water mixed with a solution of 23.5% w/v polyethylene glycol with an average molecular weight of approximately 3,300 Daltons in water in the proportion of 85% triblock copolymer solution, 15% polyethylene glycol solution v/v. When 6 microliters of that solution was mixed with sufficient polypeptide solution of the type described in Example 1 a final solution was produced including 0.0075, 0.015, 0.030, 0.045 and 0.060% w/v dodecyl maltoside and 0.75, 1.5, 3.0, 4.5 and 6.0% w/w polypeptide relative to synthetic polymer materials respectively.

### Examples Nos. 123-127

Solutions useful for producing a biocompatible membrane in accordance with the present invention were prepared generally as described in Examples Nos. 84-88 respectively, however, the synthetic polymer material used was a mixture of 10% w/v of sulfonated styrene/ethylene-butylene/sulfonated styrene, supplied as Protolyte® A700, lot number LC-29/60-011 by Dais Analytic, Odessa, Fla. in solvent as supplied, diluted 50% v/v with ethanol containing 5% v/v water mixed with a solution of 23.5% w/v polyethylene glycol with an average molecular weight of approximately 8,000 Daltons in water in the proportion of 85% triblock copolymer solution, 15% polyethylene glycol solution v/v. When 6 microliters of that solution was mixed with sufficient polypeptide solution of the type described in Example 1 a final solution was produced including 0.0075, 0.015, 0.030, 0.045 and 0.060% w/v dodecyl maltoside and 0.75, 1.5, 3.0, 4.5 and 6.0% w/w polypeptide relative to synthetic polymer materials respectively.

### Examples Nos. 128-132

Solutions useful for producing a biocompatible membrane in accordance with the present invention can be prepared generally as described in Examples Nos. 6-10 respectively, however, the synthetic polymer material used can be 5% w/v of polymethylmethacrylate-polydimethylsiloxane-polymethylmethacrylate having an average molecular weight of 4 kD-8 kD-4 kD in a solvent mixture of 50% v/v THF, 50% v/v dichloromethane. When 6 microliters of that solution is mixed with sufficient polypeptide solution of the type described in Example 1 a final solution is produced including 0.0075, 0.015, 0.030, 0.045 and 0.060% w/v dodecyl maltoside and 0.75, 1.5, 3.0, 4.5 and 6.0% w/w polypeptide relative to synthetic polymer materials respectively.

### Examples Nos. 133-134

Solutions useful for producing a biocompatible membrane in accordance with the present invention were prepared generally as described in Examples Nos. 6 and 7 respectively, however, the synthetic polymer material used was 3.2% w/v of polystyrene-polybutadiene-polystyrene, supplied as Stryolux® 3G55, lot 7453064P by BASF, Ludwigshafen Germany in a 50%/50% v/v mixture of acetone and hexane. When 6 microliters of that solution was mixed with sufficient polypeptide solution of the type described in Example 1 a final solution was produced including 0.0075 and 0.015% w/v dodecyl maltoside and 0.75 and 1.5% w/w polypeptide relative to synthetic polymer materials respectively.

### Examples Nos. 135-136

Solutions useful for producing a biocompatible membrane in accordance with the present invention were prepared generally as described in Examples Nos. 6 and 7 respectively, however, the synthetic polymer material used was 3.2% w/v of polystyrene-polybutadiene-polystyrene, supplied as Stryolux® 3G55, lot 7453064P by BASF, Ludwigshafen Germany in a 50%/50% v/v mixture of acetone and heptane. When 6 microliters of that solution was mixed with sufficient polypeptide solution of the type described in Example 1 a final solution was produced including 0.0075 and 0.015% w/v dodecyl maltoside and 0.75 and 1.5% w/w polypeptide relative to synthetic polymer materials respectively.

### Example Nos. 137-138

Solutions useful for producing a biocompatible membrane in accordance with the present invention were prepared generally as described in Examples Nos. 135 and 136 respectively, however, the synthetic polymer material used was 5% w/v of polystyrene-polybutadiene-polystyrene, supplied as Stryolux® 3G55, lot 7453064P by BASF, Ludwigshafen Germany in a 50%/50% v/v mixture of acetone and heptane. When 6 microliters of that solution was mixed with sufficient polypeptide solution of the type described in Example 1 a final solution was produced including 0.0075 and 0.015% w/v dodecyl maltoside and 0.75 and 1.5% w/w polypeptide relative to synthetic polymer materials respectively.

### Examples Nos. 139-141

Solutions useful for producing a biocompatible membrane in accordance with the present invention can be prepared generally as described in Examples Nos. 6-8 respectively, however, the synthetic polymer material used can be a mixture of 5% w/v of polystyrene-polybutadiene-polystyrene, supplied as Stryolux® 3G55, lot 7453064P by BASF, Ludwigshafen Germany in a 50%/50% v/v mixture of acetone and hexane and 5% w/v poly(2-methyloxazoline)-polydimethylsiloxane-poly(2-methyloxazoline) having an average molecular weight of 2 kD-5 kD-2 kD in the same solvent in the proportion of about 80% v/v to 20% v/v, respectively. When 6 microliters of that solution is mixed with sufficient polypeptide solution of the type described in Example 1 a final solution is produced including 0.0075, 0.015, and 0.030% w/v dodecyl maltoside and 0.75, 1.5 and 3.0% w/w polypeptide relative to synthetic polymer materials respectively.

### Examples Nos. 142-145

Solutions useful for producing a biocompatible membrane in accordance with the present invention can be prepared generally as described in Examples Nos. 139-141 respectively, however, the synthetic polymer material used can be a mixture of 5% w/v of polystyrene-polybutadiene-polystyrene, supplied as Stryolux® 3G55, lot 7453064P by BASF, Ludwigshafen Germany in a 50%/50% v/v mixture of acetone and hexane and 5% w/v poly(2-methyloxazoline)-polydimethylsiloxane-poly(2-methyloxazoline) having an average molecular weight of 3 kD-7 kD-3 kD in the same solvent in the proportion of about 80% v/v to 20% v/v, respectively. When 6 microliters of that solution is mixed with sufficient polypeptide solution of the type described in Example 1 a final solution is produced including 0.0075, 0.015, and 0.030% w/v dodecyl maltoside and 0.75, 1.5 and 3.0% w/w polypeptide relative to synthetic polymer materials respectively.

### Examples Nos. 146-290

Solutions useful for producing a biocompatible membrane in accordance with the present invention can be prepared generally as described in Examples Nos. 1-145, respectively, however, the polypeptide solution mixed with the synthetic polymer can be a solution of 10 mg/ml of Succinate:ubiquinone oxidoreductase (Complex II) in water which also can include 0.15% Thesit (polyoxyethylene(9)dodecyl ether, C₁₂E₉) available from Roche, Indianapolis, Ind. This surfactant replaces, in general, the dodecyl maltoside in examples 1-145 in similar concentration.

### Examples Nos. 291-435

Solutions useful for producing a biocompatible membrane in accordance with the present invention can be prepared generally as described in Examples Nos. 1-145, respectively, however, the polypeptide solution used to dilute the synthetic polymer can be a solution of 10 mg/ml of Nicotinamide Nucleotide Transhydrogenase in water which also can include 0.15% Triton X-100. This surfactant replaces, in general, the dodecyl maltoside in examples 1-145 in similar concentration. Furthermore, in examples 1-145 which include dodecyl β-D-glucopyranoside, this detergent can be substituted with Nonidet P-40 in similar concentration.

### Example 436

Membranes are formed on a dielectric perforated support. The support is made of KAPTON available from DuPont (1 mil thick) and is laser-drilled with apertures of 100 micrometers in diameter and 1 mil deep. The array of apertures can have a density as high as 1,700 apertures/cm². A biocompatible membrane is formed across the apertures using the PEG 8000/PROTOLYTE A700 membrane described in detail previously. The resulting final solution containing the block copolymer, stabilizing polymer and polypeptide is then deposited onto the substrate in a manner that completely covered the apertures, dropwise by pipet, 4 microliters at a time. The solvent was allowed to evaporate at room temperature under a hood. The membrane-support assembly was stored in a vacuum chamber prior to use.

A test device, in this case a fuel cell, was constructed from DELRAN plastic. The membrane-support assembly produced as described above was sealed in place within the fuel cell with rubber gaskets to form two chambers, an anode compartment and a cathode compartment. The anode and cathode compartments were then filled (20 ml in each) with an aqueous electrolyte (1M TMA-formate pH 10 in the anode compartment and 100 mM TMA-sulfate, pH 2.0, containing 1% hydrogen peroxide in the cathode compartment). A titanium foil anode was connected in parallel to an electronically varied load. A computer with an analog/digital board was used to measure current and voltage output. The circuit was completed by wiring these elements to a graphite cathode electrode in the cathode compartment.

The titanium foil anode was immersed in the anolyte. Also contained in the anode compartment was 5% v/v methanol as fuel, 12.5 mM NAD+was used as electron carrier, 1M hydroquinone was used as electron transfer mediator, yeast alcohol dehydrogenase (5,000 units), aldehyde dehydrogenase (10 units) and formate dehydrogenase (100 units) were used as soluble enzymes. Current and voltage were produced consistent with the function of Complex I embedded in the biocompatible membrane in translocating protons from the anode compartment to the cathode compartment, even against the proton concentration gradient. Peak current density was 158 mA/cm². The membrane was stable for approximately 3 days.

By comparison, in another cell formed using the same components and concentrations as above, with the exception that the membrane-forming solution did not include PEG 8000, the peak current density was similar. However, the membrane integrity was limited to 10-12 hours. Membrane failure was assessed via visible flow of the mediator into the cathode compartment.

In the absence of Complex I in the membrane, the Protolyte block copolymer nonetheless forms membranes which are modestly permeable to protons. The use of such membranes formed without Complex I in a fuel cell, constructed similarly to those above, with the exception that 300 mM PMS was present in the anode as the electron transfer mediator instead of hydroxyquinone, produced maximally 4 mA/cm² for only a matter of approximately 5 minutes before decreasing in output rapidly.

### Example 437

An array containing four substructures made up of 1050 apertures (35 rows of 30 apertures in a hexagonal, close-packed configuration) with an aperture diameter of 110 microns were laser drilled through 1-mil polysulfone film. The array was bonded across a punched ¾-inch opening in a 15-mil polystyrene support (2.5″×2.25″) using THF-dissolved polystyrene at a concentration above 200 mg/ml as the adhesive. The bonding was performed in such a manner as to assure a liquid-tight seal around the array.

A solution of Protolyte A700 (Dais Analytic) as supplied by the manufacturer was diluted with 50% with ethanol. To 36 microliters of this solution was added 4 microliters of a solution containing 10 mg/ml of E. coli Complex 1,50 mM MES-pH 6.0, 50 mM NaCl and 0.15% dodecyl maltoside. Following mixing through pipetting up and down, the mixture was deposited onto the arrays in such a manner as to completely cover the apertures, and to produce a membrane that covered the apertures following solvent evaporation in a fume hood. The membranes were air dried in a fume hood, then moved to a vacuum oven and dried for an additional 15 minutes.

The membrane support was then assembled into a fuel cell by clamping together with screws the following layers: A polysulfone plate (3.25″×3″×½″), a piece of sheet aluminum (2.25″×3.5″×0.075 mm) with a portion of the 3.5″ extending beyond the top edge of the polysulfone block to serve as the point of electrical contact with the anode, a silicone rubber gasket (2.5″×2.25″×0.25″ with an area of 2.25″×2″ cut from the center), the membrane/support, another silicone rubber gasket, 0.125″ in thickness but otherwise similar to the first gasket, a graphite cathode (2.5″×2.25″×15 mils, Poco Graphite), and a second polysulfone plate. A wire was bonded to the graphite block with silver-based epoxy on a portion of the block that was assured to remain dry during cell operation so as to assure that readings of voltage and current were not interfered with by oxidation of the silver epoxy.

This cell was filled with approximately 6 ml of anolyte consisting of a mixture of 2.3 Molar tetramethylammonium (TMA) formate, pH 8.0 with 20% by volume 2.6 Molar TMA hydroxide. (final pH approximately 14.) and 3 ml of a catholyte consisting of a mixture of 100 mM TMA-sulfate pH 7.0, 0.1 Molar sulfuric acid, and 1% by volume hydrogen peroxide. The liquids were introduce through small apertures near the top of the polysulfone blocks through aligned apertures in the aluminum anode and graphite cathode. The apertures were not sealed during operation of the cell, though such a procedure is possible and simple.

The Cell produced 100 milliAmps with a 2-Ohm resistor and an open circuit voltage of 2.2 Volts. The peak power was approximately 50 milliwatts.

### Example 438

A set of apertures consisting of 4 arrays of 100 apertures 100 microns in diameter in a 10×10 square were laser drilled in a 1-mil Kapton substrate approximately 1″×2″ in size. A solution of polystyrene-poly(1-4 butadiene)-polystyrene triblock copolymer (Styrolux 3G55, BASF) was formed by dissolving pellets of the polymer in THF (Aldrich) to a final concentration of 50 mg/ml.

A mixture of 12.8 microliters of the polymer solution with 2.8 microliters of a solution containing 10 mg/ml of E. coli Complex I, 50 mM MES-pH 6.0, 50 mM NaCl and 0.15% dodecyl maltoside was deposited on the arrays in a such a manner as to completely cover the apertures, and to form membranes across the apertures following solvent evaporation in a fume hood. The support with membranes was then moved to a vacuum oven, and dried at room temperature for an additional 15 minutes.

A fuel cell was assembled by clamping the following layers together with screws: A polysulfone block (2″×2.51″×⅜″), a 1″×2.5″×0.25 mm piece of zinc sheet (Goodfellow) as an anode, with a portion of the zinc protruding above the polysulfone block to serve as a point of electrical contact, a silicone rubber gasket, 1″×1.75″×⅜″ cut into a U-shape of 0.25″ thickness to create access for filling liquids in the top of the cell, the membrane/support structure, a second gasket of 0.125″ thickness, but otherwise similar to the first gasket, a 1″×2.25″×15 mil graphite cathode (Poco Graphite), a second polysulfone plate.

The cell was filled with 800 microliters of the anolyte, and 500 microliters of the catholyte described in the previous example. The cell produced an open circuit voltage of 2.0 volts, with a current output of 13 milliAmps through a five-Ohm resistor. Maximum power output was approximately 6 milliwatts.

### INDUSTRIAL APPLICABILITY

The invention has applications to batteries, including fuel cells and re-chargeable fuel cells that contain a metal anode as fuel and a biocompatible membrane.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

All patent and non-patent publications cited in this specification are indicative of the level of skill of those skilled in the art to which this invention pertains. All of these publications and patent applications are herein incorporated by reference, to the same extent as if each individual publication or patent application was specifically and individually indicated to be incorporated herein by reference.

1. A fuel cell comprising: an anode compartment including an anode and a metal fuel; a cathode compartment including a cathode; and disposed within said anode compartment, within said cathode compartment, or between said anode compartment and said cathode compartment, at least one biocompatible membrane that is impervious to the passage of metals and metal ions having at least one layer of a synthetic polymer material which includes an anode side and a cathode side and at least one polypeptide associated therewith, said polypeptide capable of participating in a chemical reaction, participating in the transporting of protons from said anode side of said at least one layer to said cathode side of said at least one layer, or participating in the formation of molecular structures that facilitate such reactions or transport.

2. The fuel cell of claim 1 wherein, when said anode and said cathode are placed into electrical contact though a circuit, 10 milliwatts/cm² are generated.

3. The fuel cell of claim 2 wherein, when said anode and said cathode are placed into electrical contact though a circuit, 50 milliwatts/cm² are generated.

4. The fuel cell of claim 3 wherein, when said anode and said cathode are placed into electrical contact though a circuit, 100 milliwatts/cm² are generated.

5. The fuel cell of claim 1 wherein, said anode is made of metal.

6. The fuel cell of claim 5 wherein, said anode is said metal fuel.

7. The fuel cell of claim 1 wherein, said polypeptide is capable of participating in transporting protons from one side of said anode side of said biocompatible membrane to said cathode side of said biocompatible membrane.

8. The fuel cell of claim 1, wherein said at least one biocompatible membrane is disposed between said anode and said cathode.

9. The fuel cell of claim 1, further comprising: a dielectric material disposed between said anode and said cathode that will permit the flow of protons from said anode compartment to said cathode compartment.

10. A fuel cell comprising: an anode compartment including a metal anode which serves as fuel; a cathode compartment including a cathode; and disposed within said anode compartment, within said cathode compartment, or between said anode compartment and said cathode compartment, at least one biocompatible membrane that is impervious to the passage of metals and metal ions having at least one layer of a synthetic polymer material which includes an anode side and a cathode side and at least one polypeptide associated therewith, said polypeptide capable of participating in the transporting of protons from said anode side of said at least one layer to said cathode side of said at least one layer and wherein said synthetic polymer material consists of at least one block copolymer and optionally at least one additive.

11. The fuel cell of claim 10 wherein, when said anode and said cathode are placed into electrical contact though a circuit, 10 milliwatts/cm² are generated.

12. The fuel cell of claim 11 wherein, when said anode and said cathode are placed into electrical contact though a circuit, 50 milliwatts/cm² are generated.

13. The fuel cell of claim 2 wherein, when said anode and said cathode are placed into electrical contact though a circuit, 100 milliwatts/cm² are generated.
